(19) United States
(12) Patent Application Publication
(10) Pub. No.: US 2001/0013543 A1
(43) Pub. Date: Aug. 16, 2001

(54) Communication control apparatus having a plurality of communication processing cards and controlling data output by polling

(75) Inventors: Ken Takashima, Kawasaki (JP); Atsushi Yabe, Kanagawa (JP); Tatsuru Nakagaki, Kawasaki (JP); Hirohito Tanaka, Kanagawa (JP); Hiroaki Watanabe, Kawasaki (JP)

Correspondence Address: HELFGOTT & KARAS, P.C., 60th Floor, Empire State Building, New York, NY, 10118, US

(73) Assignee: FUJITSU LIMITED

(21) Appl. No.: 09/729,016

(22) Filed: Dec. 4, 2000

(30) Foreign Application Priority Data
Feb. 16, 2000 (JP) 2000-037654

(51) Int. Cl. G06K 5/00

(52) U.S. Cl. 235/380

(57) ABSTRACT

A communication control apparatus has a plurality of communication processing units each of which processes data, and a control unit which controls the plurality of communication processing units. The control unit includes a polling unit and an allowing unit. The polling unit polls the plurality of communication processing cards in a predetermined order. The allowing unit allows an operation of outputting data from one of the plurality of communication processing cards when the control unit receives a response from the communication processing card. Each of the plurality of communication processing units includes a responding unit and an outputting unit. The responding unit returns to the control unit a response to the polling by the polling unit when the communication processing unit has data to be output, and is polled by the polling unit. The outputting unit performs the operation of outputting data which is allowed by the allowing unit.

### BACKGROUND OF THE INVENTION

1) Field of the Invention

The present invention relates to a communication control apparatus. In particular, the present invention relates to a communication control apparatus having a plurality of communication processing units which concurrently process transmission data.

2) Description of the Related Art

In order to support the requirements of sophistication and increase in processing speed in communication systems using ATM (Asynchronous Transfer Mode) or the like, transmission data is divided into a plurality of portions, and delivered to a plurality of communication processing cards so that processing of the transmission data is performed in parallel in the plurality of communication processing cards. The processing of the transmission data includes, for example, assembling or disassembling of ATM cells, and the data processed by the plurality of communication processing cards are multiplexed by a cross-point switch or the like. For example, the multiplexed data is transmitted to another apparatus.

If each of the plurality of communication processing cards attempts to transmit the processed data at a time which is independent of times of transmission of processed data from the other communication processing cards, the data transmitted from each communication processing card is likely to collide with data transmitted from the other communication processing cards. Therefore, in order to avoid the collision, conventionally, a right of transmission is controlled by using a token.

FIG. 21 is a diagram illustrating an example of a conventional construction for controlling a right of transmission. In FIG. 21, the external interface (I/F) 1 receives ATM cells (hereinafter called cells) from an external apparatus, performs a format conversion or the like, and supplies the cells to a plurality of communication processing cards 2-1 to 2-n. Each of the communication processing cards 2-1 to 2-n disassembles the cells (or assembles data into cells), and outputs data of the disassembled cells to the external interface 4 at a time determined by timing coordination with the other communication processing cards. The token bus 3 is a bus which interconnects the communication processing cards 2-1 to 2-n, and is used for controlling a right of transmission. For example, the external interface 4 converts the format of the data output from the communication processing cards 2-1 to 2-n, and outputs the format-converted data to an external apparatus.

The operation of the construction of FIG. 21 is explained below.

When the operation of the construction of FIG. 21 is started, the communication processing card 2-1 unconditionally acquires a right of transmission. When the communication processing card 2-1 has data to be transmitted, the communication processing card 2-1 outputs the data to the external interface 4. When the operation of outputting the data is completed, the communication processing card 2-1 sends a token to the communication processing card 2-2 through the token bus 3. When the communication processing card 2-1 does not have data to be transmitted, the communication processing card 2-1 immediately sends the token to the communication processing card 2-2 through the token bus 3.

When the communication processing card 2-2 receives the token, and has data to be transmitted, the communication processing card 2-2 outputs the data to the external interface 4. When the operation of outputting the data is completed, the communication processing card 2-2 sends the token to the communication processing card 2-3 through the token bus 3. When the communication processing card 2-2 does not have data to be transmitted, the communication processing card 2-2 immediately sends the token to the communication processing card 2-3 through the token bus 3.

By repeating the above operation, the token is transferred to each communication processing card 2-1 to 2-n in sequence. Since the token is returned from the communication processing card 2-n to the communication processing card 2-1, the token (i.e., a right of transmission) circulates through the plurality of communication processing cards 2-1 to 2-n.

FIG. 22 is a diagram illustrating another example of a conventional construction for controlling a right of transmission. The construction of FIG. 22 is different from the construction of FIG. 21 in that a token ring bus 5 is provided instead of the token bus 3 in FIG. 21. The other portions of the construction of FIG. 22 are identical to the corresponding portions of the construction of FIG. 21.

The operation of the construction of FIG. 22 is identical to the operation of the construction of FIG. 21 except that the token ring bus 5 physically forms a loop for transferring a token, while the construction of FIG. 21 logically forms a loop for transferring a token.

However, when at least one of the plurality of communication processing cards 2-1 to 2-n is uninstalled or out of order in the constructions of FIGS. 21 and 22, the token cannot circulate through the plurality of communication processing cards 2-1 to 2-n. Therefore, it is necessary to counter such a problem.

FIG. 23 is a diagram illustrating an example of an operation of transferring a token in consideration of the case where at least one of the plurality of communication processing cards 2-1 to 2-n is uninstalled or out of order. In FIG. 23, the communication processing cards 2-1 to 2-n are indicated by #1 to #n, respectively.

When the communication processing card 2-1 sends a token to the communication processing card 2-2 as indicated by a1 in FIG. 23, the communication processing card 2-2 returns a predetermined response to the communication processing card 2-1 as indicated by a2 in FIG. 23. Therefore, the communication processing card 2-1 can recognize that the token is appropriately transferred to the communication processing card 2-2. That is, the right of transmission is transferred to the communication processing card 2-2. Thereafter, when processing of the communication processing card 2-2 is completed, the token is transmitted to the communication processing card 2-3 as indicated by a3 in FIG. 23. When the communication processing card 2-3 is uninstalled or out of order, the communication processing card 2-2 cannot receive a response as indicated by a4 in FIG. 23. Each communication processing card has an internal counter, which obtains a length of time which elapses after the token is transmitted to the communication processing card 2-3. When the count exceeds a predetermined value “k”, the communication processing card 2-2 aborts the operation of transferring the token to the communication processing card 2-3, and starts an operation of transferring the token to the next communication processing card 2-4, as indicated by a4 in FIG. 23. By repeating the above operation, the token can be appropriately transferred to each of the normally installed communication processing cards in sequence.

Namely, according to the above procedure, the token can appropriately circulate through all of the normally installed communication processing cards even when at least one communication processing card is uninstalled or out of order.

However, in the constructions of FIGS. 21 and 22, an attempt to transfer a token to each of the communication processing cards is made in sequence even when at least one of the communication processing cards is uninstalled, or does not have transmission data. Therefore, the response processing performed between communication processing cards takes a long time. In particular, when a communication processing card is uninstalled, it is necessary to wait for a response from the communication processing card until the timer (counter) expires. Therefore, processing is delayed.

In addition, in systems in which high speed data transfer is required (e.g., in switching systems in which call processing signals are required to be transferred at high speed), the above delay causes an overflow of data from a data buffer and a loss of data. However, when the buffer capacity is increased in order to prevent the overflow, the total cost of the system increases since the buffer memories are expensive.

Further, when multimedia data is transferred, it is necessary to appropriately give a right of transmission to a plurality of communication processing cards according to a type and an amount of data. However, since, conventionally, the concept of the priority has not been introduced in the systems in which a token is circulated, it is impossible to appropriately transfer multimedia data. This problem is most serious in the case where the multimedia data includes data of sound, a moving picture, or the like, which is required to be processed on a real-time basis. In addition, when the system is busy, it is impossible to secure isochronism of multimedia data.

Since the construction of FIG. 22 (i.e., a so-called token ring system) is simpler than the construction of FIG. 21 (i.e., a so-called token bus system), the time needed for transferring the token in the construction of FIG. 22 is shorter than the time needed in the construction of FIG. 21. However, it is impossible to transfer the token in the construction of FIG. 22 when at least one communication processing card is uninstalled, since the physical loop for transferring the token cannot be formed when at least one communication processing card is uninstalled. Therefore, when the system is in operation, each communication processing card cannot be pulled out from the communication control apparatus for maintenance.

### SUMMARY OF THE INVENTION

An object of the present invention is to provide a communication control apparatus in which a right of transmission can be promptly given to a plurality of communication processing cards, and a substantial transmission rate can be increased.

Another object of the present invention is to provide a communication control apparatus which requires a relatively small data buffer, and is consequently inexpensive.

Still another object of the present invention is to provide a communication control apparatus which can transfer data efficiently and securely.

A further object of the present invention is to provide a communication control apparatus which is easy to inspect and maintain.

According to the present invention, there is provided a communication control apparatus comprising a plurality of communication processing units each of which processes data; and a control unit which controls the plurality of communication processing units. The control unit comprises a polling unit and an allowing unit. The polling unit polls the plurality of communication processing cards in a first order which is predetermined. The allowing unit allows an operation of outputting data from one of the plurality of communication processing cards when the control unit receives a response from the one of the plurality of communication processing cards. Each of the plurality of communication processing units comprises a responding unit and an outputting unit. The responding unit returns to the control unit a response to polling by the polling unit when the each of the plurality of communication processing units has data to be output, and is polled by the polling unit. The outputting unit performs the operation of outputting data which is allowed by the allowing unit.

The communication control apparatus according to the present invention may also have one or any possible combination of the following additional features (i) and (xv).

(i) The communication control apparatus according to the present invention may further comprise at least one control line which interconnects the control unit and the plurality of communication processing cards, and the polling unit may poll each of the plurality of communication processing cards by outputting onto the at least one control line identification information identifying each communication processing card.

(ii) The communication control apparatus according to the present invention may further comprise an installation detecting unit which detects whether or not each of the plurality of communication processing cards is installed, and the polling unit may omit polling at least one of the plurality of communication processing cards when the installation detecting unit detects that the at least one of the plurality of communication processing cards is not installed.

(iii) The communication control apparatus according to the present invention may further comprise a time measuring unit which measures an elapsed time after the allowing unit allows the operation of outputting data from one of the plurality of communication processing cards, and the polling unit may poll another of the plurality of communication processing cards when a predetermined time elapses after the allowing unit allows the above operation.

(iv) Each of the plurality of communication processing cards may further comprise an informing unit which informs the control unit that the operation of outputting data from the one of the plurality of communication processing cards is completed, and the polling unit may poll another of the plurality of communication processing cards when the control unit is informed by the informing unit that the above operation is completed.

(v) In the communication control apparatus having the feature of (iv), the polling unit may poll another of the plurality of communication processing cards when a predetermined time elapses after the allowing unit allows the above operation, and the control unit is not informed by the informing unit that the above operation is completed.

(vi) The polling unit may poll another of the plurality of communication processing cards which is arranged at a top of the first order, when the operation of outputting data from one of the plurality of communication processing cards is completed.

(vii) When the operation of outputting data from one of the plurality of communication processing cards is completed, the polling unit may poll another of the plurality of communication processing cards which follows the above communication processing card in the first order.

(viii) The polling unit may successively poll one of the plurality of communication processing cards when the responding unit in the communication processing card sends to the control unit a request for allowance of successive output of data.

(ix) The communication control apparatus according to the present invention may further comprise a memorizing unit which memorizes at least one response received from at least one of the plurality of communication processing cards, and the allowing unit may allow an operation of outputting data from each of the at least one of the plurality of communication processing cards in a second order determined in a predetermined way, after a cycle of operations of polling all of the plurality of communication processing cards is completed.

(x) In the communication control apparatus having the feature of (ix), the second order may be determined according to priorities assigned to the plurality of communication processing cards.

(xi) In the communication control apparatus having the feature of (ix), the second order may be determined based on information included in each of the at least one response.

(xii) In the communication control apparatus having the feature of (xi), the information included in each response may be determined based on importance or a type of the data to be transmitted from one of the at least one of the plurality of communication processing cards which returns the response.

(xiii) In the communication control apparatus having the feature of (xi), the information included in each response may be determined based on an amount of data which is held in a data buffer provided in one of the at least one of the plurality of communication processing cards which returns the response.

(xiv) The allowing unit may allow the operation of outputting data from one of the plurality of communication processing cards, immediately after the control unit receives the response from the one of the plurality of communication processing cards, or after a cycle of operations of polling all of the plurality of communication processing cards is completed, based on whether or not the response is a type which indicates a request for immediate allowance.

(xv) In the communication control apparatus having the feature of (xiv), the responding unit in each of the plurality of communication processing cards may return the above type or another type of response, according to an amount of data held in a data buffer provided in the each of the plurality of communication processing cards.

### BRIEF DESCRIPTION OF THE DRAWINGS

In the drawings:

FIG. 1 is a diagram illustrating a basic construction of a communication control apparatus according to the present invention;

FIG. 2 is a block diagram illustrating an example of a communication control apparatus to which the present invention is applied;

FIG. 3 is a timing diagram illustrating an example of an operation of the communication control apparatus, performed in the first embodiment of the present invention;

FIG. 4 is a block diagram illustrating an example of a format of signals which are output onto control lines;

FIG. 5 is a sequence diagram illustrating an example of an operation performed between the control unit and the plurality of communication processing cards in the construction of FIG. 2;

FIG. 6 is a diagram illustrating examples of operations of the communication control apparatus, performed in the first embodiment of the present invention;

FIG. 7 is a timing diagram illustrating examples of operations of the communication control apparatus, performed in the second embodiment of the present invention;

FIG. 8 is a timing diagram illustrating examples of operations of the communication control apparatus, performed in the third embodiment of the present invention;

FIG. 9 is a timing diagram illustrating examples of operations of the communication control apparatus, performed in the fourth embodiment of the present invention;

FIG. 10 is a timing diagram illustrating examples of operations of the communication control apparatus, performed in the fifth embodiment of the present invention;

FIG. 11 is a timing diagram illustrating examples of operations of the communication control apparatus, performed in the sixth embodiment of the present invention;

FIG. 12 is a timing diagram illustrating examples of operations of the communication control apparatus, performed in the seventh embodiment of the present invention;

FIG. 13 is a timing diagram illustrating examples of operations of the communication control apparatus, performed in the eighth embodiment of the present invention;

FIG. 14 is a block diagram illustrating an example of a construction realizing a data buffer;

FIGS. 15 and 16 are timing diagrams illustrating examples of operation of the communication control apparatus, performed in the ninth embodiment of the present invention;

FIGS. 17 and 18 are timing diagrams illustrating examples of operation of the communication control apparatus, performed in the tenth embodiment of the present invention;

FIG. 19 is a timing diagram illustrating examples of operations of the communication control apparatus, performed in the eleventh embodiment of the present invention;

FIG. 20 is a timing diagram illustrating examples of operations of the communication control apparatus, performed in the twelfth embodiment of the present invention;

FIG. 21 is a diagram illustrating an example of a conventional construction for controlling a right of transmission;

FIG. 22 is a diagram illustrating another example of a conventional construction for controlling a right of transmission; and

FIG. 23 is a diagram illustrating an example of an operation of transferring a token in consideration of the case where at least one communication processing card is uninstalled or out of order.

### DESCRIPTION OF THE PREFERRED EMBODIMENTS

Embodiments of the present invention are explained below with reference to drawings.

(1) Principle of Invention

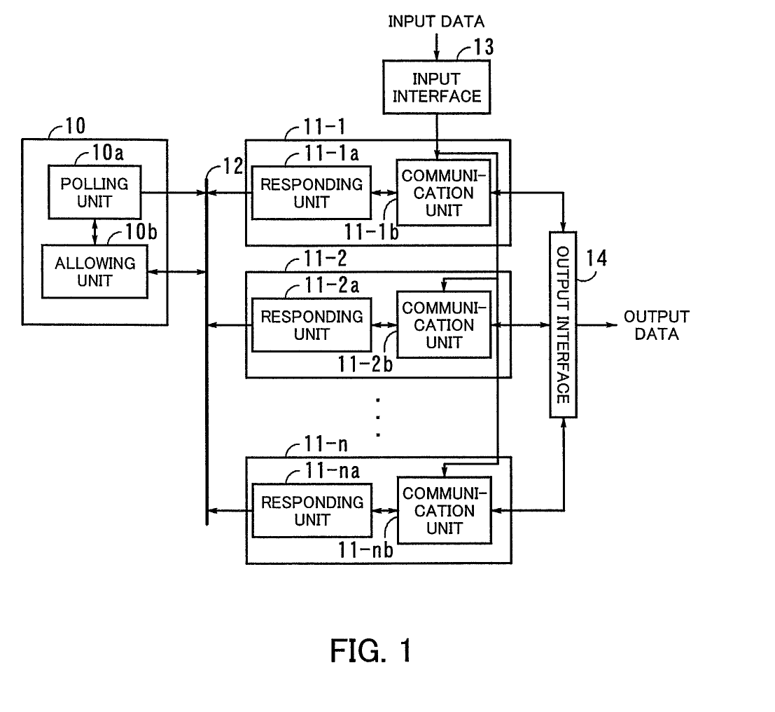

FIG. 1 is a diagram illustrating a basic construction of a communication control apparatus according to the present invention.

The communication control apparatus of FIG. 1 comprises a control unit 10, communication processing cards 11-1 to 11-n, a bus 12, an input interface 13, and an output interface 14. The control unit 10 includes a polling unit 10a and an allowing unit 10b, and controls the communication processing cards 11-1 to 11-n. The polling unit 10a polls the communication processing cards 11-1 to 11-n one by one in a predetermined order through the bus 12. When one of the communication processing cards 11-1 to 11-n which is polled by the polling unit 10a returns a response to the polling, the allowing unit 10b allows the communication processing card to conduct communication. Each of the communication processing cards 11-1 to 11-n comprises a response unit and a communication unit. For example, the communication processing card 11-1 comprises a response unit 11-1a and a communication unit 11-1b. Each communication processing card performs predetermined processing (e.g., assembling and disassembling) of data which is input into the communication processing card through the input interface 13, and outputs the processed data to the output interface 14.

When one of the communication processing cards 11-1 to 11-n has data to be output (transmitted), and is polled by the polling unit 10a, the response unit (e.g., the response unit 11-1a) returns a predetermined response to the control unit 10. When one of the communication processing cards 11-1 to 11-n is allowed by the allowing unit 10b to conduct communication, the communication unit (e.g., the communication unit 11-1b) performs predetermined processing of the data which is input through the input interface 13, and outputs the processed data to the output interface 14.

The bus 12 interconnects the control unit 10 and the communication processing cards 11-1 to 11-n, and enables exchange of information between the control unit 10 and the communication processing cards 11-1 to 11-n. The input interface 13 converts a format of data, which is received from an external apparatus. The output interface 14 adapts the format of the processed data to the format of an external apparatus.

The operation of the communication control apparatus of FIG. 1 is explained below.

When the operation of the communication control apparatus of FIG. 1 is started, data which is input through the input interface 13 is supplied to the communication processing cards 11-1 to 11-n according to the type of data. Each of the communication processing cards 11-1 to 11-n performs predetermined processing of the data supplied to the communication processing card, and stores the processed data in a data buffer (not shown) provided in the communication processing card. In addition, when the operation of the communication control apparatus of FIG. 1 is started, the polling unit 10a first polls the communication processing card 11-1 by outputting onto the bus 12 information (e.g., a polling signal) which indicates the communication processing card 1-1. For example, the polling unit 10a outputs onto the bus 12 identification information which is assigned to the communication processing card 1-1. When the communication processing card 11-1 receives the identification information, recognizes that the identification information indicates the communication processing card 11-1, and has data to be transmitted, in the data buffer, the communication processing card 11-1 returns a predetermined response signal to the control unit 10 through the bus 12 by using the response unit 11-1a. When the control unit 10 receives the response signal, the allowing unit 10b in the control unit 10 outputs onto the bus 12 an allowance signal which indicates allowance of data transmission by the communication processing card 11-1. When the communication processing card 11-1 receives the allowance signal, the communication processing card 11-1 outputs the data to be transmitted, to the output interface 14. As explained later, a maximum transmission period of the transmission is predetermined. Therefore, the communication processing card 11-1 transmits the data within the maximum transmission period. When the communication processing card 11-1 does not have data to be transmitted, the communication processing card 11-1 do nothing. When a predetermined time elapses after the allowing unit 10b outputs the allowance signal to the communication processing card 11-1, the polling unit 10a outputs onto the bus 12 identification information which indicates the next communication processing card 11-2. Then, the communication processing card 11-2 performs similar operations to the above operations performed by the communication processing card 11-1. That is, when the communication processing card 11-2 has data to be transmitted, the communication processing card 11-2 outputs the data to the output interface 14 in a similar manner to the manner in which the communication processing card 11-1 outputs the data to the output interface 14. When the predetermined time elapses after the allowing unit 10b outputs the allowance signal to the communication processing card 11-2, the polling unit 10a outputs onto the bus 12 identification information which indicates the next communication processing card 11-3. By repeating similar operations, the communication processing cards 11-1 to 11-n are cyclically polled one by one.

Since the response signal is returned to the control unit 10 only when the polled communication processing card is installed, and has data to be transmitted, it is possible to prevent the delay in processing caused by the unnecessary response processing.

(2) Example of Communication Control Apparatus

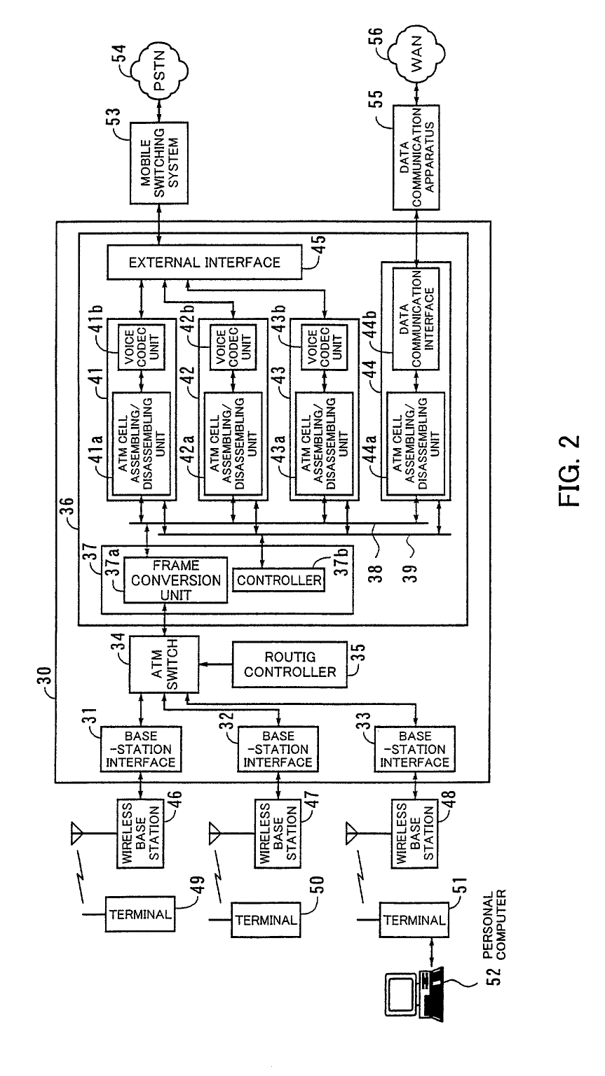

FIG. 2 is a block diagram illustrating an example of a communication control apparatus to which the present invention is applied. The communication control apparatus 30 of FIG. 2 comprises base station interfaces 31 to 33, an ATM switch (ATMS) 34, a routing controller 35, and a switching-system interface 36. The switching-system interface 36 comprises a switching control unit 37, an ATM cell bus 38, control lines 39, communication processing cards 41 to 44, and an external interface 45. The switching control unit 37 comprises a frame conversion unit 37a and a controller 37b. The communication processing cards 41 to 43 comprise ATM-cell assembling/disassembling units 41a to 43a and voice CODECs (coder-decoders) 41b to 43b, respectively, and the communication processing card 44 comprises an ATM-cell assembling/disassembling unit and a data communication interface 44b.

Wireless base stations 46 to 48 are connected to the base station interfaces 31 to 33 of the communication control apparatus 30, respectively. The wireless base stations 46 to 48 exchange information with the communication terminals 49 to 51, which are, for example, mobile telephones. The information exchanged between the wireless base stations 46 and 47 and the communication terminals 49 and 50 includes voice data, and the wireless base station 48 exchanges data with a personal computer 52 through the communication terminal 51.

The external interface 45 of the communication control apparatus 30 is connected to a mobile switching system 53, which is connected to a public switched telephone network (PSTN) 54. The data communication interface 44b is connected to a data communication apparatus 55, which is connected to a wide area network (WAN) 56.

The functions of the above constituent elements of the communication control apparatus 30 are explained below.

When the base station interfaces 31 to 33 exchange information with the wireless base stations 46 to 48, the base station interfaces 31 to 33 perform protocol termination processing or the like. The wireless base stations 46 to 48 exchange information with the communication terminals 49 to 51, and perform processing for originating a call, when necessary. The ATM switch 34 performs routing processing for ATM cells output from the frame conversion unit 37a, under control of the routing controller 35. The routing controller 35 controls the routing processing performed by the ATM switch 34. The switching-system interface 36 performs processing for converting the protocol and the format of data.

The switching control unit 37 performs serial/parallel conversion of signals between the ATM switch 34 and the communication processing cards 41 to 44, and controls the communication processing cards 41 to 44. The frame conversion unit 37a performs conversions between parallel signals on the ATM cell bus 38 and serial signals output from or input into the ATM switch 34. The controller 37b controls the communication processing cards 41 to 44 through the control lines 39.

Each of the communication processing cards 41 to 43 performs processing for assembling data into cells, disassembling cells, and coding and decoding voice data. The communication processing card 44 is provided for data communication, and performs processing such as conversions between ATM cells and IP (Internet Protocol) packet. The ATM-cell assembling/disassembling units 41a to 43a receive and disassemble cells on the ATM cell bus 38, and supply the disassembled ATM cells to the voice CODECs 41b to 43b, respectively. The ATM-cell assembling/disassembling unit 44a receives and disassembles cells on the ATM cell bus 38, and supplies the disassembled ATM cells to the data communication interface 44b. In addition, the ATM-cell assembling/disassembling units 41a to 43a receive data from the voice CODECs 41b to 43b, respectively, assemble the data into ATM cells, and output the ATM cells onto the ATM cell bus 38. The ATM-cell assembling/disassembling unit 44a receives data from the data communication interface 44b, assembles the data into ATM cells, and outputs the ATM cells onto the ATM cell bus 38. The voice CODECs 41b to 43b compress voice signals supplied from the external interface 45 to bandwidths assigned to the voice CODECs 41b to 43b, respectively, and decode compressed voice data supplied from the ATM-cell assembling/disassembling units 41a to 44a, respectively. The data communication interface 44b performs processing such as conversions between IP packets and ATM cells. The external interface 45 performs conversions of formats of data and the like in order to exchange information with the mobile switching system 53. The PSTN 54 is a public network which enables communication with a desired party. The data communication apparatus 55 is realized by, for example, a router, and performs processing such as translation of addresses contained in headers of packets which are supplied from the data communication interface 44b. The WAN 56 enables transmission of data between the communication control apparatus 30 and a desired party. For example, the construction of FIG. 2 operates as follows.

Voice signals transmitted through the PSTN 54 are input into the communication control apparatus 30 through the mobile switching system 53, and supplied to the external interface 45. The external interface 45 delivers the voice signals to the voice CODECs 41b to 43b. The voice CODECs 41b to 43b compress the voice signals. On the other hand, digital data in data communication transmitted through the WAN 56 are input into the communication control apparatus 30 through data communication apparatus 55, and supplied to the data communication interface 44b. The data communication interface 44b appropriately converts the data format of the digital data, and supplies the digital data to the ATM-cell assembling/disassembling unit 44a. The ATM-cell assembling/disassembling units 41a to 44a assemble ATM cells from the data respectively supplied from the voice CODECs 41b to 43b and the data communication interface 44b, and store the ATM cells in data buffers, which are provided in the respective ATM-cell assembling/disassembling units 41a to 44a. The ATM cells stored in the data buffers are read out onto the ATM cell bus 38 in sequence under the control of the controller 37b. The data read out from the data buffers are multiplexed on the ATM cell bus 38, and supplied to the frame conversion unit 37a. Details of operations of controlling the communication processing cards 41 to 44 by the controller 37b are explained later. The frame conversion unit 37a converts the ATM cells which are multiplexed on the ATM cell bus 38, into serial signals. The ATM switch 34 performs switching (routing) of the ATM cells supplied from the frame conversion unit 37a under the control of the routing controller 35, and supplies the ATM cells to the base station interfaces 31 to 33. The base station interfaces 31 to 33 perform processing for protocol termination on the ATM cells supplied from the ATM switch 34, and supplies the ATM cells to the wireless base stations 46 to 48. The wireless base stations 46 to 48 transmit the data supplied from the base station interfaces 31 to 33, to the communication terminals 49 to 51 over the air. The communication terminals 49 to 51 receive the wireless signals transmitted from the wireless base stations 46 to 48, and regenerate the original voice signals or digital data.

(3) First Embodiment

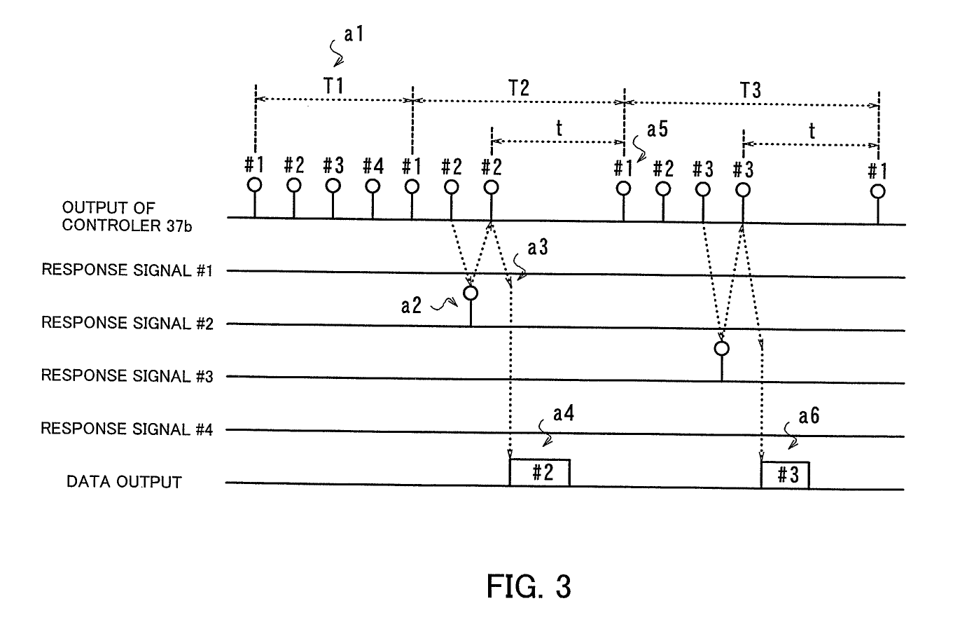

The operations of the communication control apparatus 30 of FIG. 2, performed in the first embodiment of the present invention, are explained below with reference to FIGS. 3 to 6.

FIG. 3 is a timing diagram illustrating an example of the operation of giving a right of transmission to the communication processing cards 41 to 44, performed in the first embodiment of the present invention. In FIG. 3, timings of the polling signals which are output from the controller 37b onto the control lines 39 for polling the communication processing cards 41 to 44, responses from the communication processing cards 41 to 44 (#1 to #4), and data output onto the ATM cell bus 38 are indicated.

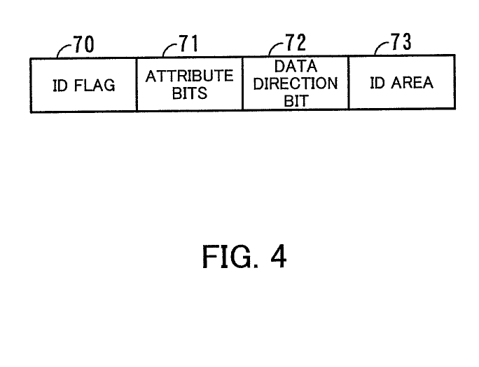

FIG. 4 exhibits an example of a format of signals which are output onto the control lines 39. The format of FIG. 4 includes an ID flag 70, attribute bits 71, a data direction bit 72, and an ID area 73. The ID flag 70 is realized by a predetermined bit pattern which indicates the top of the polling signal. When each communication processing card or the controller 37b detects the ID flag 70, the communication processing card or the controller 37b recognizes that the contents of a polling signal or an allowance signal or a response signal follows the ID flag 70, and acquires the contents of the polling signal or the allowance signal or the response signal. The attribute bits 71 indicate a type of data which a communication processing card transmits next. The data direction bit 72 indicates whether the data is transmitted in the direction from the switching control unit 37 to a communication processing card, or in the direction from a communication processing card to the switching control unit 37. The ID area 73 contains an identifier of a communication processing card. For example, the identifiers ID=1, 2, 3, and 4 are assigned to the communication processing cards 41 to 44, respectively. In the following explanations, signals on the control lines 39 which contain the identifiers (identification numbers) ID of the communication processing cards 41 to 44 are indicated by #1 to #4, respectively.

As indicated by a1 in FIG. 3, the controller 37b first outputs onto the control lines 39 polling signals #1 to #4 for polling the communication processing cards 41 to 44 in this order. When no response signal is returned from the communication processing cards 41 to 44, a cycle of operations of sending polling signals to the communication processing cards 41 to 44 is completed within the time T1 as indicated by a1. In the next cycle (during the time T2), the communication processing card 42 has data to be transmitted. Therefore, when the controller 37b outputs a polling signal #2 onto the control lines 39, the communication processing card 42 detects the identifier of the communication processing card 42 in the polling signal #2, and returns a response signal as indicated by a2 in FIG. 3, where the response signal contains the identifier of the communication processing card 42. Then, the controller 37b recognizes that the communication processing card 42 requests a right of transmission, and outputs onto the control lines 39 an allowance signal #2 which indicates that the communication processing card 42 is allowed to transmit data, as indicated by a3 in FIG. 3. Thus, the communication processing card 42 recognizes that a right of transmission is given to the communication processing card 42, and outputs onto the ATM cell bus 38 the data stored in the data buffer of the communication processing card 42, as indicated by a4 in FIG. 3. At this time, the controller 37b suspends its operation until the transmission of the data by the communication processing card 42 is completed. When a predetermined time t elapses after the above allowance signal #2 is output, the controller 37b restarts its operation. That is, the controller 37b outputs a polling signal #1 onto the control lines 39 as indicated by a5 in FIG. 3.

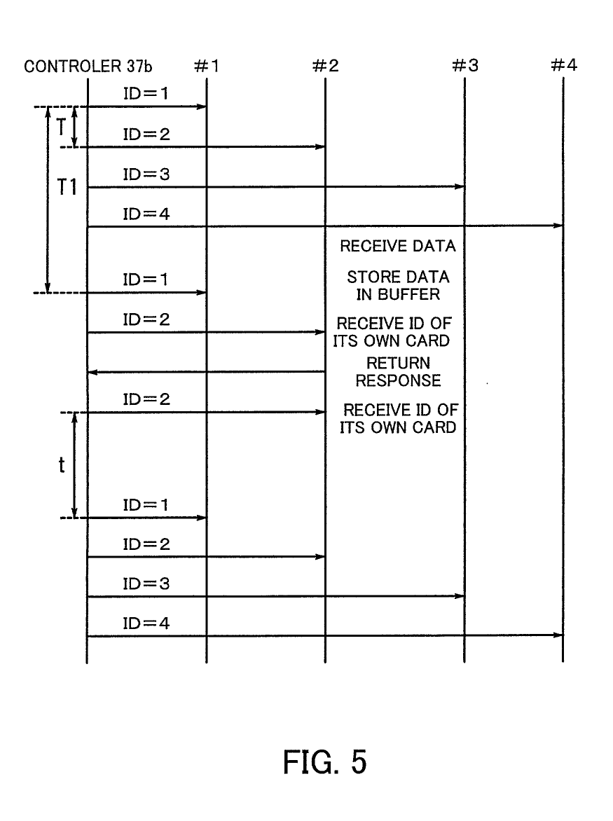

FIG. 5 is a sequence diagram illustrating operations performed between the controller 37b and the plurality of communication processing cards 41 to 44 in the construction of FIG. 2.

As indicated in FIG. 5, the first cycle of the operation of polling the communication processing cards 41 to 44 is completed within the time T1 since the communication processing cards 41 to 44 do not have data to be transmitted, and do not respond to the polling signal from the controller 37b, where the interval between successive polling signals is a predetermined time T.

In the second cycle of the operation of polling the communication processing cards 41 to 44, when a polling signal containing the identifier ID=2 is output onto the control lines 39, the communication processing card 42 returns a response signal, and the controller 37b outputs onto the control lines 39 an allowance signal containing the identifier ID=2. Therefore, the communication processing card 42 recognizes that a right of transmission is given to the communication processing card 42, and starts transmission of data. When the time t elapses after the output of the allowance signal, the controller 37b restarts the operation of outputting a polling signal to each communication processing card in sequence, where the third cycle of the operation of polling the communication processing cards 41 to 44 is started from an output of a polling signal to the communication processing card 41.

As described above, according to the present invention, each communication processing card returns a response to a polling signal only when the communication processing card has data to be transmitted, and acquires a right of transmission. In the conventional communication control apparatus, the communication between communication processing cards is conducted irrespective of whether each communication processing card has data to be transmitted. However, according to the present invention, the communication between communication processing cards is dispensed with, and therefore the processing speed can be increased.

The flows of operations performed in the communication control apparatus of FIG. 3 in the first embodiment of the present invention are explained below.

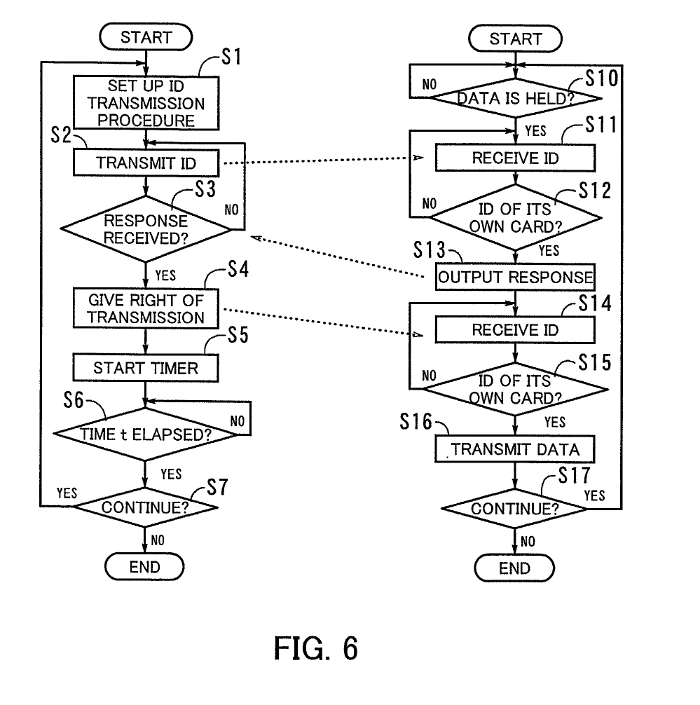

FIG. 6 is a diagram illustrating examples of operations of the communication control apparatus, performed in the first embodiment of the present invention. In FIG. 6, the operations in steps S1 to S7 are performed in the controller 37b, and the operations in steps S10 to S17 are performed in each communication processing card.

First, the operations of the controller 37b are explained below.

In step S1, the controller 37b sets up a procedure of transmission of polling signals respectively containing identifiers ID. The procedure is determined so that the controller 37b outputs onto the control lines 39 polling signals for polling the communication processing cards 41 to 44 one by one in this order. In step S2, the controller 37b outputs a polling signal onto the control lines 39 in accordance with the procedure set up in step S1. For example, a polling signal containing the identifier ID of the communication processing card 41 is first output. In step S3, the controller 37b determines whether or not the communication processing card returns a response to the polling signal. When “yes” is determined in step S3, the operation goes to step S4. When “no” is determined in step S3, the operation goes back to step S2. In step S4, the controller 37b outputs an allowance signal to the communication processing card which returns the response signal to give a right of transmission to the communication processing card. In step S5, the controller 37b starts a timer (not shown). In step S6, the controller 37b determines whether or not the predetermined time t elapses. When “yes” is determined in step S6, the operation goes to step S7. When “no” is determined in step S6, the controller 37b waits for reception of the response signal. In step S7, the controller 37b determines whether or not the sequence of steps S1 to S6 is to be continued. When “yes” is determined in step S7, the operation goes to step S1. When “no” is determined in step S7, the sequence of steps S1 to S7 is completed.

Next, the operations in steps S10 to S17 for the communication processing card 41 are explained below. In step S10, the communication processing card 41 determines whether or not the communication processing card 41 has data to be transmitted. When “yes” is determined in step S10, the operation goes to step S11. When “no” is determined in step S10, the communication processing card 41 waits for data supplied through the external interface 45. In step S11, the communication processing card 41 receives the polling signal which is output from the controller 37b in step S2. In step S12, the communication processing card 41 determines whether or not the identifier ID contained in the received polling signal is the identifier of the communication processing card 41. When “yes” is determined in step S12, the operation goes to step S13. When “no” is determined in step S12, the operation goes back to step S11. In step S13, the communication processing card 41 performs processing for outputting a response signal to the controller 37b. Consequently, the response signal is detected by the controller 37b in step S3. In step S14, the communication processing card 41 receives an allowance signal which indicates that a right of transmission is given by the controller 37b to a communication processing card. In step S15, the communication processing card 41 determines whether or not the identifier ID contained in the received allowance signal is the identifier of the communication processing card 41. When “yes” is determined in step S15, the operation goes to step S16. When “no” is determined in step S15, the operation goes back to step S14. In step S16, the communication processing card 41 starts transmission of data. In step S17, the communication processing card 41 determines whether or not the sequence of steps S10 to S16 is to be continued. When “yes” is determined in step S17, the operation goes to step S10. When “no” is determined in step S17, the sequence of steps S10 to S17 is completed.

Thus, in accordance with the sequences of FIG. 6, the operations explained with reference to FIGS. 3 and 5 can be realized.

(4) Second Embodiment

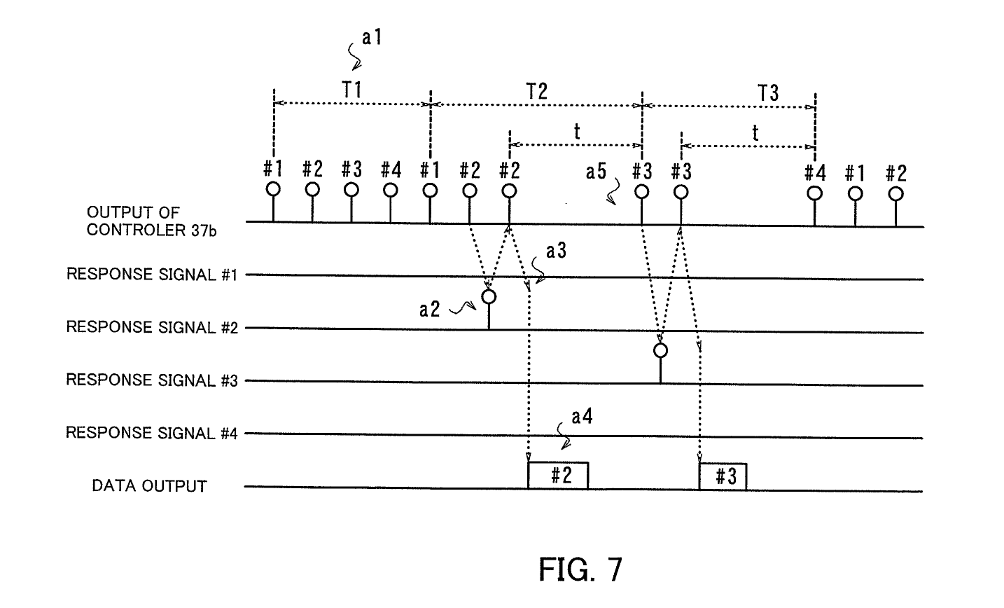

The operations of the communication control apparatus 30 of FIG. 2, performed in the second embodiment of the present invention, are explained below with reference to FIG. 7, which is a timing diagram illustrating examples of operations of the communication control apparatus, performed in the second embodiment of the present invention. The second embodiment is different from the first embodiment in the operation performed after each communication processing card outputs data onto the ATM cell bus 38. In the first embodiment, after transmission of data from a communication processing card is completed, the operation of outputting a polling signal to each communication processing card in sequence is restarted from an output of a polling signal to the first communication processing card #1. On the other hand, in the second embodiment, after transmission of data from a communication processing card is completed, the operation of outputting a polling signal to each communication processing card in sequence is restarted from an output of a polling signal to the next communication processing card in the cyclic order. That is, the operation of outputting a polling signal to each communication processing card in sequence is restarted from an output of a polling signal to the communication processing card 43 (as indicated by a5 in FIG. 7) after transmission of data from the communication processing card 42 (as indicated by a4 in FIG. 7) is completed, and the operation of outputting a polling signal to each communication processing card in sequence is restarted from an output of a polling signal to the communication processing card 44 after transmission of data from the communication processing card 43 is completed. In the first embodiment, communication processing cards having lower identification numbers can acquire a right of transmission with a higher priority. On the other hand, in the second embodiment, all of the communication processing cards can acquire a right of transmission with an equal probability.

(5) Third Embodiment

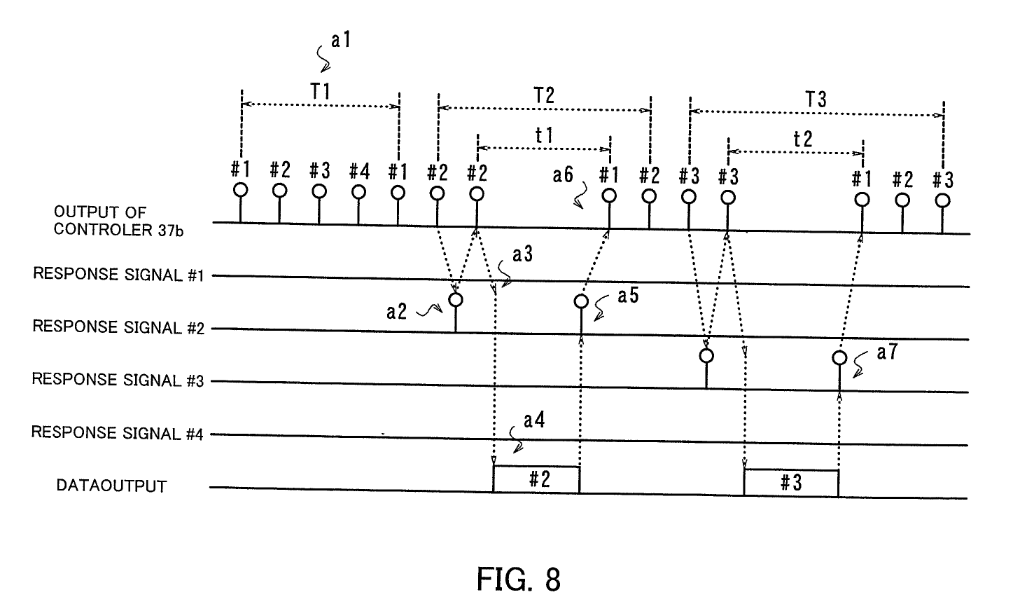

The operations of the communication control apparatus 30 of FIG. 2, performed in the third embodiment of the present invention, are explained below with reference to FIG. 8, which is a timing diagram illustrating examples of operations of the communication control apparatus, performed in the third embodiment of the present invention. The third embodiment is different from the first embodiment in the operation performed after each communication processing card outputs data onto the ATM cell bus 38. In the third embodiment, after transmission of data from a communication processing card is completed, the communication processing card outputs a transmission complete signal onto the control lines 39, where the transmission complete signal contains the identification number ID of the communication processing card, and indicates that the transmission of data by the communication processing card is completed. For example, the communication processing card 42 outputs a transmission complete signal onto the control lines 39 as indicated by a5 in FIG. 8. When the controller 37b receives the transmission complete signal, the controller 37b recognizes that the transmission of data by the communication processing card 42 is completed, and restarts the operation of outputting a polling signal to each communication processing card in sequence. In the example of FIG. 8, the operation of outputting a polling signal to each communication processing card in sequence is restarted from an output to the first communication processing card 41. Since, in the third embodiment of the present invention, the controller 37b is informed by the transmission complete signal of the completion of the transmission of data, the controller 37b can restart the operation of outputting a polling signal to each communication processing card in sequence, immediately after the completion of the transmission of data, and the processing speed is further increased.

(6) Fourth Embodiment

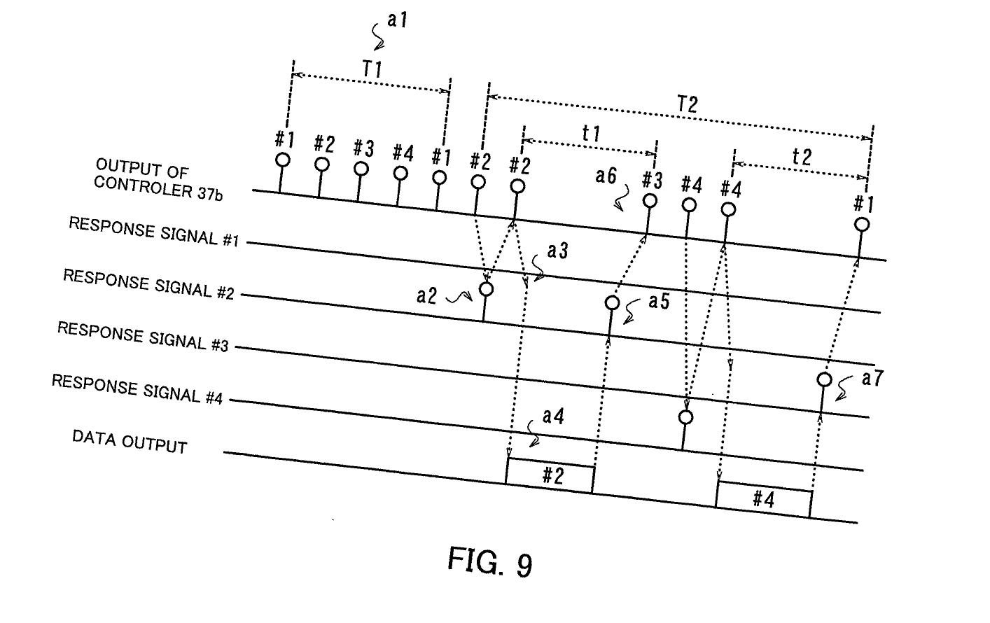

The operations of the communication control apparatus 30 of FIG. 2, performed in the fourth embodiment of the present invention, are explained below with reference to FIG. 9, which is a timing diagram illustrating examples of operations of the communication control apparatus, performed in the fourth embodiment of the present invention. The operations of the fourth embodiment is similar to the operations of the third embodiment, except that the operation of outputting a polling signal to each communication processing card in sequence is restarted from the next communication processing card in the cyclic order as in the second embodiment, after the controller 37b detects the transmission complete signal. For example, when the controller 37b receives a transmission complete signal containing the identification number ID of the communication processing card 42 (as indicated by a5 in FIG. 9), the controller 37b recognizes that the transmission of data by the communication processing card 42 is completed, and the operation of outputting a polling signal to each communication processing card in sequence is restarted from an output to the next communication processing card 43 in the cyclic order. Therefore, in the fourth embodiment of the present invention, the processing speed is further increased, and all of the communication processing cards can acquire a right of transmission with an equal probability.

(7) Fifth Embodiment

In the fifth embodiment, priority levels of the communication processing cards are stored in advance in the communication control apparatus. The priority levels may be set in the communication control apparatus, for example, by arranging special hardware, e.g., a DIP (dual in-line package) switch, for setting a priority level in each communication processing card, or by assigning priority levels to positions in which the communication processing cards are installed, e.g., slots into which the communication processing cards are inserted, respectively. Alternatively, the priority levels may be assigned by the controller 37b to the communication processing cards by software.

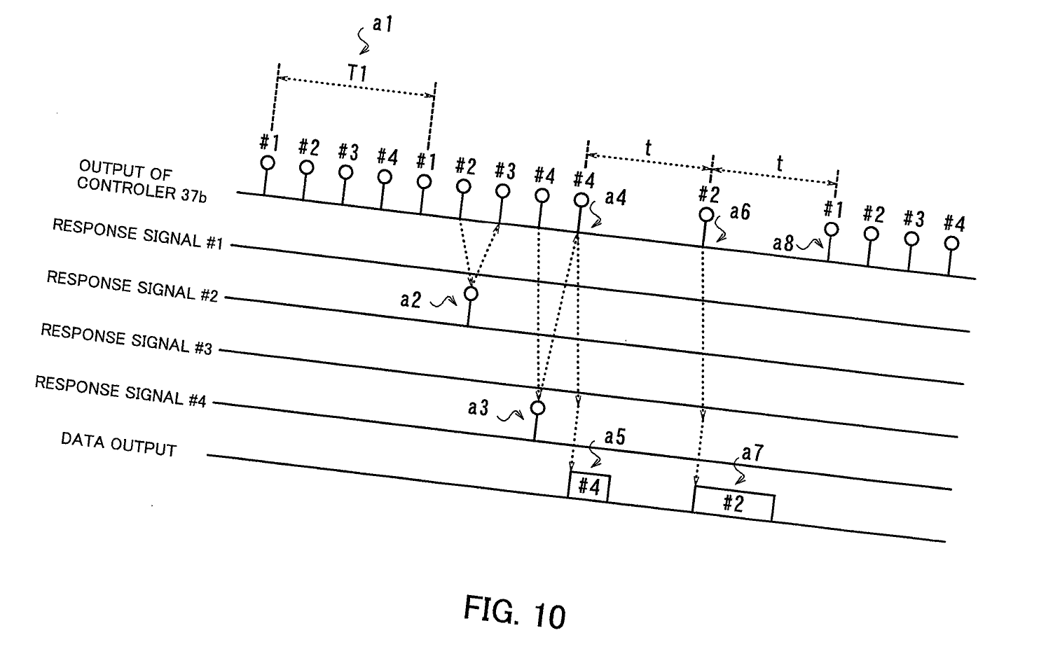

The operations of the communication control apparatus 30 of FIG. 2, performed in the fifth embodiment of the present invention, are explained below with reference to FIG. 10, which is a timing diagram illustrating examples of operations of the communication control apparatus, performed in the fifth embodiment of the present invention.

First, the controller 37b outputs onto the control lines 39 a polling signal directed to each of the communication processing cards 41 to 44 in sequence, as indicated by a1 in FIG. 10. Since, in this example, the communication processing cards 41 to 44 do not respond to the polling signal, the first cycle of the operation of outputting a polling signal to each of the communication processing cards 41 to 44 is completed within the time T1. In the next cycle of the operation of outputting a polling signal to each of the communication processing cards 41 to 44, the communication processing cards 42 and 44 respond to the polling signal by outputting response signals as indicated by a2 and a3, respectively, and the controller 37b receives and memorizes the response signals. When the output of the polling signal to the communication processing card 44 is completed, the controller 37b first acquires information on the response signal from the communication processing card having the highest priority. For example, when the priority levels of the communication processing cards 41 to 44 are “2”, “3”, “4”, and “1”, respectively, the controller 37b first acquires information on the response signal from the communication processing card 44 having the highest priority level “1”. Then, the controller 37b outputs onto the control lines 39 an allowance signal #4 which allows the communication processing card 44 to transmit data as indicated by a4. Thus, the communication processing card 44 acquires a right of transmission, and transmits data, as indicated by a5. The controller 37b is in an a standby state until a predetermined time t elapses after the output of the allowance signal #4. When the time t elapses, the controller 37b acquires information on the response signal from the communication processing card 42 having the next highest priority level “3”, and outputs onto the control lines 39 an allowance signal #2 directed to the communication processing card 42, as indicated by a6. Thus, the communication processing card 42 acquires a right of transmission, and transmits data, as indicated by a7. When the time t elapses after the output of the allowance signal #2, the controller 37b restarts the operation of outputting a polling signal to each of the communication processing cards 41 to 44 in sequence from an output to the communication processing card 41, as indicated by a8.

Thus, in the fifth embodiment of the present invention, priority levels can be assigned to the respective communication processing cards according to load ratios of the communication processing cards or user service, and a right of transmission can be given to the communication processing cards in the priority order. Therefore, a communication processing card on which a heavy load is imposed can transmit data with a higher priority, and it is possible to realize differentiation in user service.

(8) Sixth Embodiment

The sixth embodiment is different from the first embodiment in that the controller 37b has a function of detecting uninstallation and malfunction of the communication processing cards. The uninstallation and malfunction of each communication processing card can be detected, for example, by arranging a control line for each communication processing card, and outputting an identification signal at an “H” level from each installed communication processing card onto the control line. In this case, the signal on the control line becomes an “L” level when the communication processing card is uninstalled or out of order. Therefore, the uninstallation and malfunction of each communication processing card can be detected by the controller 37b.

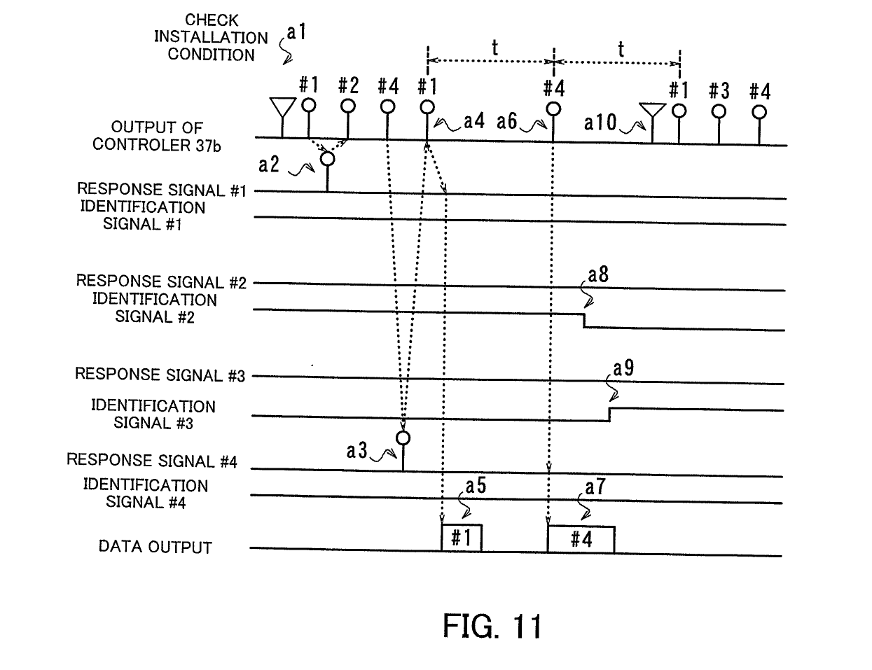

The operations of the communication control apparatus 30 of FIG. 2, performed in the sixth embodiment of the present invention, are explained below with reference to FIG. 11, which is a timing diagram illustrating examples of operations of the communication control apparatus, performed in the sixth embodiment of the present invention.

Before outputting a polling signal to the communication processing cards 41 to 44, the controller 37b checks the identification signal on the above control line for uninstallation and malfunction of each communication processing card as indicated by a1. Since, in the example of FIG. 11, the identification signal of the communication processing card 43 is at the “L” level, the communication processing card 43 is uninstalled or out of order. In this case, the controller 37b outputs onto the control lines 39 a polling signal directed to each of the communication processing cards except for the communication processing card 43 in sequence. In this example, each of the communication processing cards 41 and 44 returns a response signal to the controller 37b as indicated by a2 and a3 in FIG. 11. Therefore, the controller 37b first outputs an allowance signal #1 so as to give the communication processing card 41 a right of transmission as indicated by a4, and the communication processing card 41 transmits data as indicated by a5. When a predetermined time t elapses after the output of the allowance signal #1, the controller 37b outputs an allowance signal #4 so as to give the communication processing card 44 a right of transmission as indicated by a6, and the communication processing card 44 transmits data as indicated by a7. In the next cycle, the controller 37b checks the identification signal on the control line for uninstallation and malfunction of each communication processing card as indicated by a10, before outputting polling signals to the communication processing cards 41 to 44. In this example, during the transmission of data from the communication processing card 44, the identification signal of the communication processing card 42 changes from the “H” level to the “L” level as indicated by a8, and the identification signal of the communication processing card 43 changes from the “L” level to the “H” level as indicated by a9. Therefore, the controller 37b outputs onto the control lines 39 a polling signal directed to each of the communication processing cards 41, 43, and 44 in sequence.

Thus, in the sixth embodiment of the present invention, uninstallation and malfunction of each communication processing card are checked by the controller 37b, and the controller 37b outputs a polling signal to only the communication processing cards which is installed and normal. Therefore, it is possible to avoid spending useless time for an output of a polling signal to an uninstalled or faulty communication processing card, and thus the processing speed can be further increased.

(9) Seventh Embodiment

In the seventh embodiment, each communication processing card outputs a transmission complete signal onto the control lines 39 after transmission of data from the communication processing card is completed in a similar manner to the third embodiment. However, in the seventh embodiment, when a communication processing card changes to an non-operational condition after a right of transmission is given to the communication processing card, the controller 37b proceeds to the next operation without waiting for reception of the transmission complete signal.

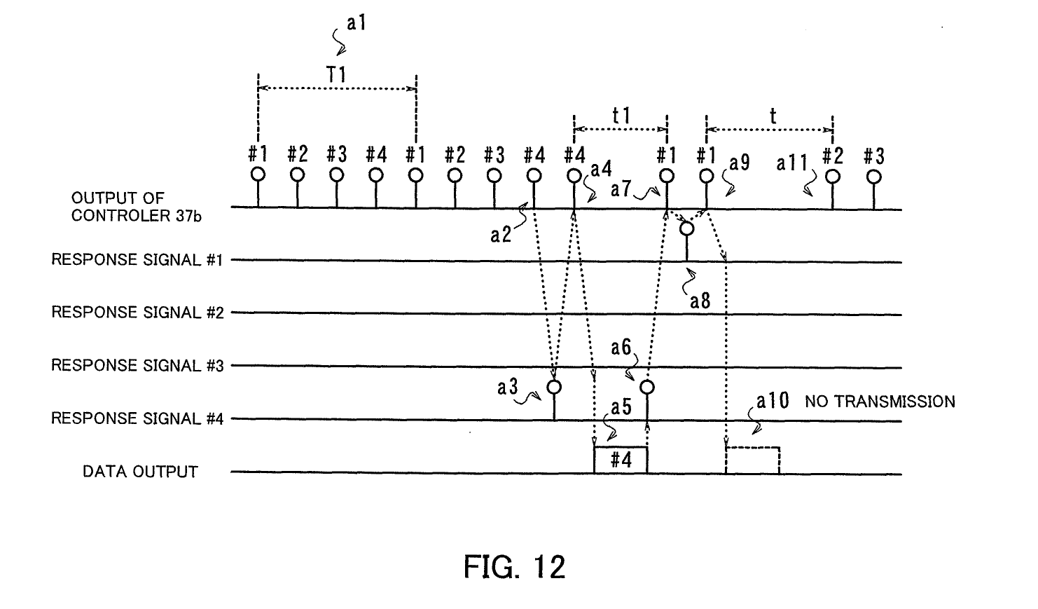

The operations of the seventh embodiment of the present invention are explained below with reference to FIG. 12, which is a timing diagram illustrating examples of operations of the communication control apparatus, performed in the seventh embodiment of the present invention.

First, the controller 37b outputs onto the control lines 39 a polling signal directed to each of the communication processing cards 41 to 44 in sequence, as indicated by a1 in FIG. 12. Since, in this example, the communication processing cards 41 to 44 do not respond to the polling signal in the first cycle of the operation of outputting a polling signal to each of the communication processing cards 41 to 44, the first cycle is completed within the time T1. In the second cycle of the operation of outputting a polling signal to each of the communication processing cards 41 to 44, only the communication processing card 44 responds to the polling signal as indicated by a3, and the controller 37b outputs an allowance signal #4 to the communication processing card 44 to give a right of transmission to the communication processing card 44, as indicated by a4. Thus, the communication processing card 44 transmits data as indicated by a5. When the transmission of data from a communication processing card 44 is completed, the communication processing card 44 outputs a transmission complete signal onto the control lines 39, as indicated by a6. When the controller 37b receives the transmission complete signal, the controller 37b proceeds to the operation of outputting a polling signal to each of the communication processing cards 41 to 44 in the next (third) cycle, as indicated by a7. When the communication processing card 41 receives the polling signal in the third cycle, and has data to be transmitted, the communication processing card 41 returns a response signal, as indicated by a8, and the controller 37b outputs onto the control lines 39 an allowance signal #1 directed to the communication processing card 41 to give a right of transmission to the communication processing card 41, as indicated by a9. If, at this time, a malfunction occurs in the communication processing card 41, or the communication processing card 41 is pulled out from the communication control apparatus, the communication processing card 41 can neither transmit the data, nor output a transmission complete signal, as indicated by a10. In order to prepare for such a case, the switching control unit 37b starts an internal counter to obtain a length of time which elapses after the controller 37b outputs an allowance signal. When a predetermined time t elapses, the controller 37b proceeds to the next operation without waiting for reception of the transmission complete signal. That is, when a predetermined time t elapses, the controller 37b outputs a polling signal #2 to the communication processing card 42, as indicated by a11.

Since, in the seventh embodiment of the present invention, it is possible to prevent the controller 37b from uselessly waiting for reception of a transmission complete signal from an uninstalled or faulty communication processing card.

Although, in the example of FIG. 12, the operation of outputting a polling signal to each of the communication processing cards 41 to 44 in sequence is restarted from the output to the next communication processing card in the cyclic order, after the completion of data transmission or the elapse of the predetermined time t, the operation of outputting a polling signal to each of the communication processing cards 41 to 44 in sequence may be restarted from an output to the first communication processing card 41.

(10) Eighth Embodiment

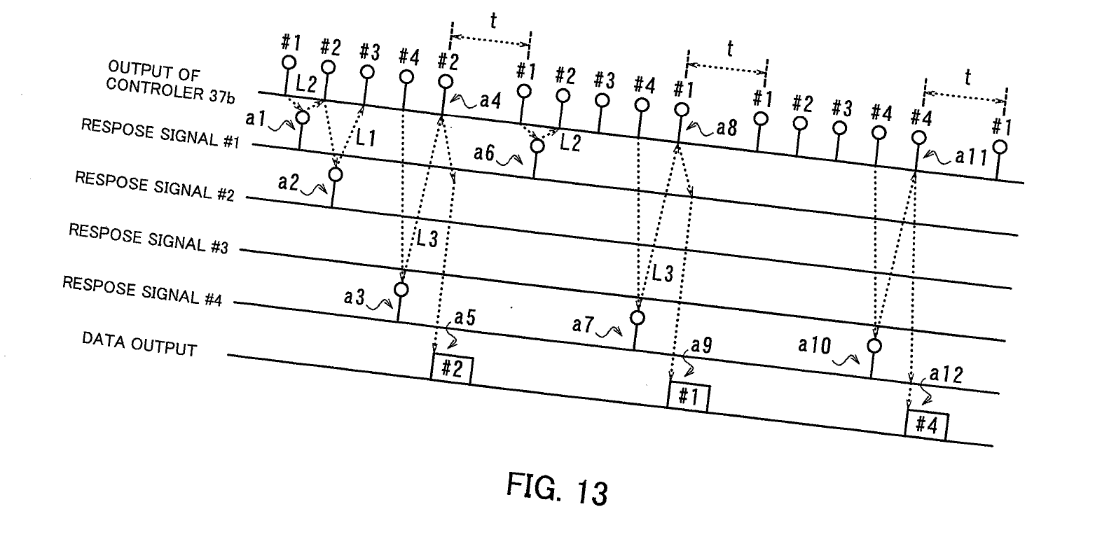

FIG. 13 is a timing diagram illustrating examples of operations of the communication control apparatus, performed in the eighth embodiment of the present invention. The eighth embodiment is different from the first embodiment in that each communication processing card informs the controller 37b of a priority level of data to be transmitted.

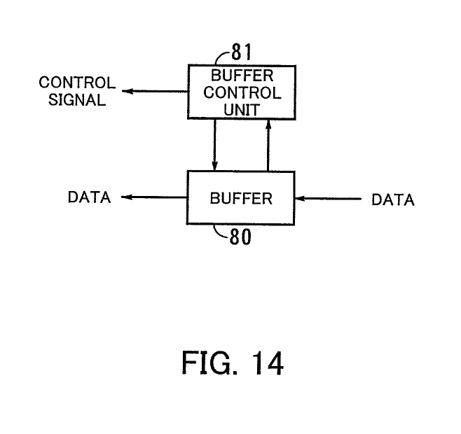

FIG. 14 is a block diagram illustrating an example of a construction realizing a data buffer, which is provided in each communication processing card. In the construction of FIG. 14, the buffer 80 temporarily stores data supplied from the ATM cell assembling/disassembling unit, and outputs the data onto the ATM cell bus 38. The buffer control unit 81 controls the buffer 80. In addition, the buffer control unit 81 acquires information on the data stored in the buffer 80, and outputs onto the control lines 39 signals having the format of FIG. 4 and containing the acquired information in the area of the attribute bits 71. The information on the data may indicate the importance of the data as well as the type of the data.

The operations of the communication control apparatus 30 of FIG. 2, performed in the eighth embodiment of the present invention, are explained below with reference to FIG. 13.

In the first cycle of the operation of outputting a polling signal to each of the communication processing cards 41 to 44, the communication processing cards 41, 42, and 44 return response signals indicating priority levels L2, L1, and L3, as indicated by a1, a2, and a3, respectively. The priority level L1 is the highest, followed by the priority levels L2, L3, and L4, in decreasing order. The buffer control unit 81 selects one of the priority levels based on the importance of the data which is stored in the buffer 80, and is to be transmitted next. Then, the buffer control unit 81 attaches the selected priority level to the response signal which is output onto the control lines 39. The importance of the data is, for example, the importance of a packet in which the data is contained. The importance of data is determined, for example, as follows: signaling of emergency calls>moving picture data>voice data>still image data>data of data communication. The emergency calls include, for example, a police call or fire call. The controller 37b detects the response signal output onto the control lines 39, and memorizes the information on the response signal, associated with the identification number ID of the communication processing card. In the first cycle of FIG. 13, the priority levels L2, L1, and L3 attached to the response signals are memorized, respectively associated with the identification numbers ID=1, 2, and 4 (indicating the communication processing cards 41, 42, and 44). When the operation of outputting the polling signals to all of the communication processing cards 41 to 44 is completed in the first cycle, the controller 37b first acquires the memorized information on the response signal having the highest priority level, and outputs an allowance signal corresponding to the response signal. Since, in this case, the highest priority level is L1, the controller 37b outputs an allowance signal to the communication processing card 42 so as to give a right of transmission to the communication processing card 42, as indicated by a4 in FIG. 13. Thus, the communication processing card 42 can first transmit data, as indicated by a5. When a predetermined time t elapses after the allowance signal is output to the communication processing card 42, the controller 37b starts the operation of outputting a polling signal to each of the communication processing cards 41 to 44 in the second cycle. Since, in this example, the communication processing cards 41 and 44 have not yet completed data transmission, for which the communication processing cards 41 and 44 returns the response signals in the first cycle, the communication processing cards 41 and 44 returns the response signals again in the second cycle, as indicated by a6 and a7. The controller 37b receives the response signals, and outputs an allowance signal to the communication processing card 41 having a higher priority level to give a right of transmission to the communication processing card 41, as indicated by a8. Thus, the communication processing card 41 transmits data, as indicated by a9. In the third cycle of the operation of outputting a polling signal to each of the communication processing cards 41 to 44, the communication processing card 44, which still has data to be transmitted, returns a response signal as indicated by a10, and the other communication processing cards do not return a response signal. The controller 37b outputs an allowance signal to the communication processing card 44 to give a right of transmission to the communication processing card 44, as indicated by a11. Thus, the communication processing card 44 transmits data, as indicated by a12. When more than one communication processing card having an identical priority level returns a response signal in the same cycle, the controller 37b may give a right of transmission to one of the more than one communication processing card which is determined in the order of #1, #2, #3, and #4.

Since, in the eighth embodiment of the present invention, the right of transmission is given to each of communication processing cards which has data to be transmitted, in the order of the priority level of the data to be transmitted. Therefore, transmission of more important data can precede transmission of less important data, and thus it is possible to prevent decrease in reliability due to information loss.

(11) Ninth Embodiment

The ninth embodiment is different from the first embodiment in that each communication processing card informs the controller 37b of a delay tolerance of data to be transmitted. The delay tolerance of the data to be transmitted may be sent to the controller 37b in a similar manner to the manner in which the priority level is sent to the controller 37b in the eighth embodiment. That is, information on the delay tolerance of the data to be transmitted may be stored in the buffer 80 in the construction of FIG. 14. Then, the buffer control unit 81 may acquire from the buffer 80 the information on the delay tolerance of data to be transmitted next, and attach the acquired information to the response signal which is output onto the control lines 39.

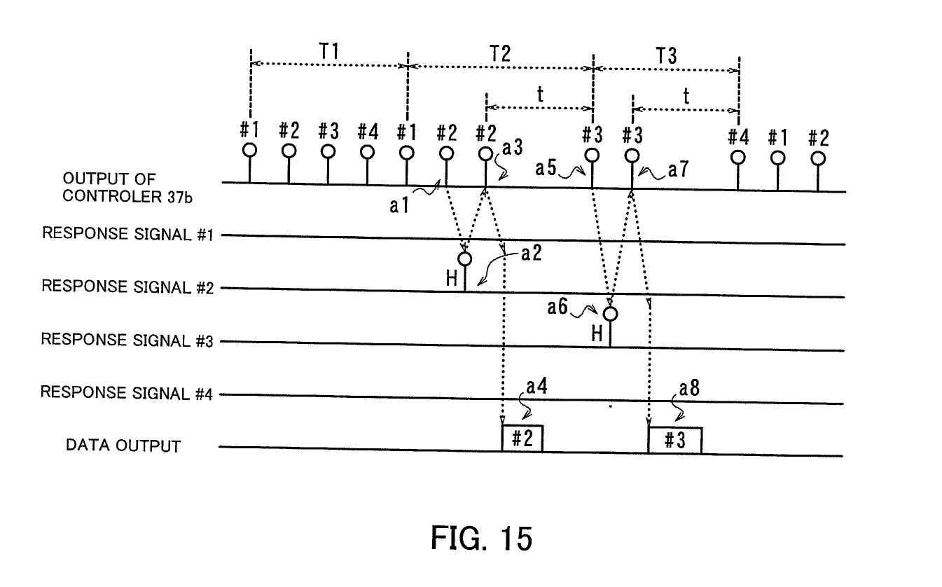

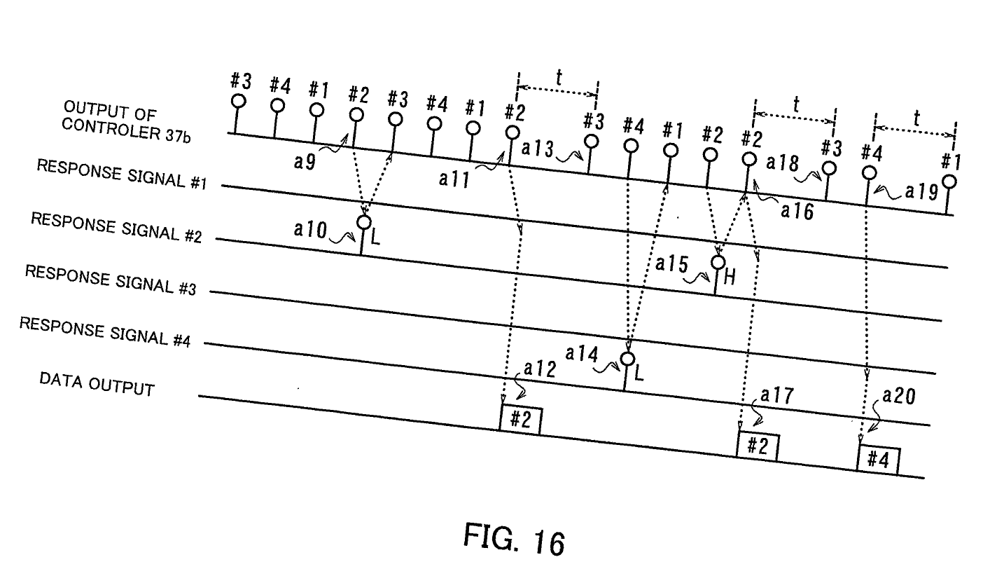

The operations of the ninth embodiment of the present invention are explained below with reference to FIGS. 15 and 16, which are timing diagrams illustrating examples of operations of the communication control apparatus, performed in the ninth embodiment of the present invention.

Since, in this example, the communication processing cards 41 to 44 do not respond to the polling signal in the first cycle of the operation of outputting a polling signal to each of the communication processing cards 41 to 44, the first cycle is completed within the time T1.

In the next (second) cycle of the operation of outputting a polling signal to each of the communication processing cards 41 to 44, the communication processing card 42 returns a response signal with information “H”, as indicated by a2 in FIG. 15, when the controller 37b outputs a polling signal #2 to the communication processing card 42 as indicated by a1, where the information “H” indicates that the delay tolerance of data to be transmitted from the communication processing card 43 is small. Therefore, the controller 37b immediately outputs an allowance signal #2 to the communication processing card 42 to give a right of transmission to the communication processing card 42, as indicated by a3. Thus, the communication processing card 42 transmits data as indicated by a4.

When a predetermined time t elapses after the output of the allowance signal #2, the controller 37b outputs the next polling signal #3 onto the control lines 39, as indicated by a5, and the communication processing card 43 returns a response signal with information “H” indicating that the delay tolerance of the data to be transmitted from the communication processing card 43 is small, as indicated by a6. Therefore, the controller 37b immediately outputs an allowance signal #3 to the communication processing card 43 to give a right of transmission to the communication processing card 43, as indicated by a7. Thus, the communication processing card 43 transmits data as indicated by a8.

When a predetermined time t elapses after the output of the allowance signal #3, the controller 37b outputs the next polling signal #4 to the communication processing card 44. The communication processing card 44 does not return a response signal in this cycle. Further, in the next (third) cycle of the operation of outputting a polling signal to each of the communication processing cards 41 to 44, the communication processing cards 41 to 44 do not respond to the polling signal as indicated in FIGS. 15 and 16.

In the fourth cycle of the operation of outputting a polling signal to each of the communication processing cards 41 to 44, which is indicated in FIG. 16, the communication processing card 42 returns a response signal with information “L”, as indicated by a10 in FIG. 16, when the controller 37b outputs a polling signal #2 to the communication processing card 42 as indicated by a9, where the information “L” indicates that the delay tolerance of the data to be transmitted is relatively large. Therefore, when the controller 37b receives the response signal, the controller 37b does not output an allowance signal, and only memorizes information on the response signal with information “L” from the communication processing card 42. Then, the controller 37b outputs the next polling signal to the communication processing card 43.

Thereafter, when the controller 37b outputs a polling signal #2 to the communication processing card 42, as indicated by a11 in FIG. 16, in the fifth cycle of the operation of outputting a polling signal to each of the communication processing cards 41 to 44, the communication processing card 42 recognizes that a right of transmission is given to the communication processing card 42, and transmits data as indicated by a12. When a predetermined time t elapses after the output of the polling signal #2, the controller 37b outputs the next polling signals #3 and #4 to the communication processing cards 43 and 44, respectively, in sequence, as indicated by a13. The communication processing card 44 returns a response signal with information “L” indicating that the delay tolerance of the data to be transmitted is relatively large, as indicated by a14. Therefore, when the controller 37b receives the response signal, the controller 37b does not output an allowance signal, and only memorizes information on the response signal with information “L” from the communication processing card 44. Then, the controller 37b outputs the next polling signal to the communication processing card 41, i.e., starts the sixth cycle of the operation of outputting a polling signal to each of the communication processing cards 41 to 44.

In the sixth cycle, when the polling signal #2 is output to the communication processing card 42, the communication processing card 42 returns a response signal with information “H” indicating that the delay tolerance of the data to be transmitted from the communication processing card 42 is small, as indicated by a15. Therefore, the controller 37b immediately outputs an allowance signal #2 to the communication processing card 42 to give a right of transmission to the communication processing card 42, as indicated by a16. Thus, the communication processing card 42 transmits data as indicated by a17. When a predetermined time t elapses after the output of the polling signal #2, the controller 37b outputs the next polling signals #3 and #4 to the communication processing cards 43 and 44, respectively, in sequence, as indicated by a18 and a19. In this case, when the controller 37b outputs a polling signal #4 to the communication processing card 44 as indicated by a19 in FIG. 16, the communication processing card 44 recognizes that a right of transmission is given to the communication processing card 44, and transmits data as indicated by a20. When a predetermined time t elapses after the output of the polling signal #4, the controller 37b outputs the next polling signal to the communication processing card 41, i.e., starts the next (seventh) cycle of the operation of outputting a polling signal to each of the communication processing cards 41 to 44.

As described above, in the ninth embodiment of the present invention, information on the delay tolerance of data to be transmitted is sent to the controller 37b with a response signal to a polling signal, and the controller 37b immediately gives a right of transmission to a communication processing card when the delay tolerance is small. Therefore, the reliability of the communication control apparatus can be increased.

(12) Tenth Embodiment

The tenth embodiment is different from the first embodiment in that each communication processing card informs the controller 37b whether or not the amount of data stored in the buffer exceeds a predetermined amount, which is close to the full capacity of the buffer 80. In order to realize the above function, the buffer control unit 81 in FIG. 14 monitors the condition of the buffer 80. When the amount of data stored in the buffer exceeds a predetermined amount, the buffer control unit 81 attaches information that the amount of data stored in the buffer exceeds the predetermined amount, to the attribute bits 71 in the format of FIG. 4, which is sent to the controller 37b through the control lines 39.

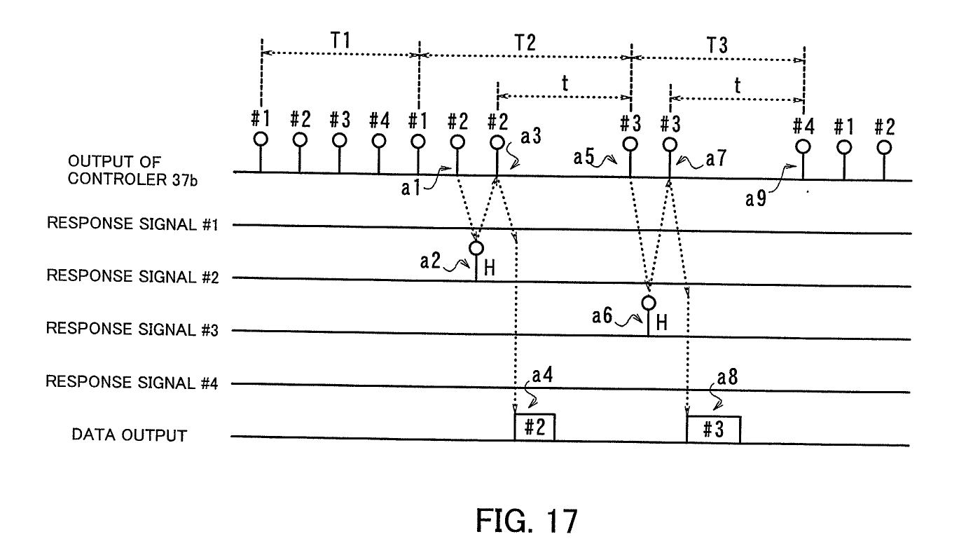

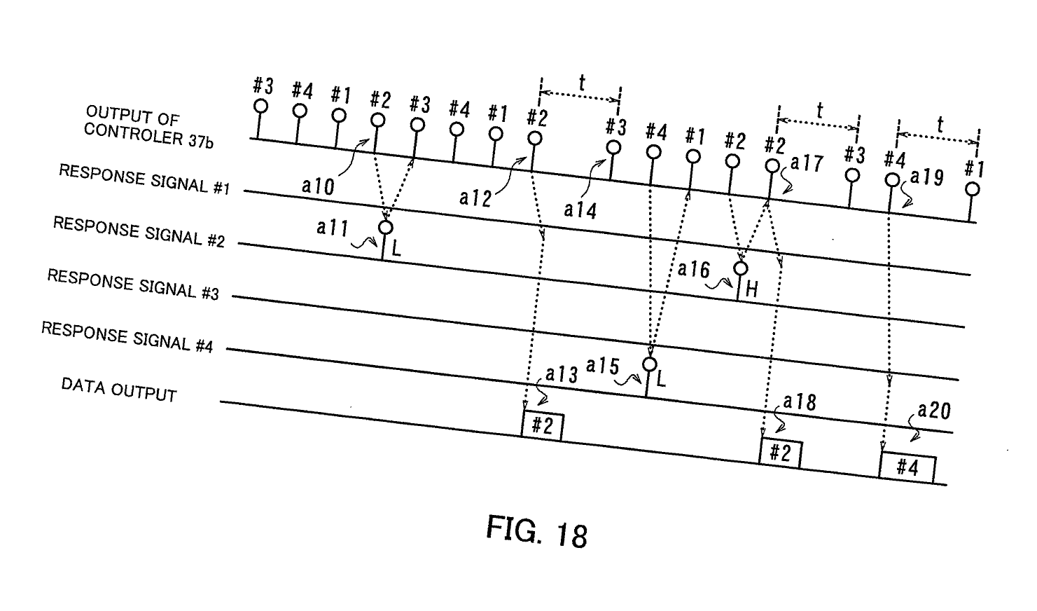

The operations of the tenth embodiment of the present invention are explained below with reference to FIGS. 17 and 18, which are timing diagrams illustrating examples of operation of the communication control apparatus, performed in the tenth embodiment of the present invention.

Since, in this example, the communication processing cards 41 to 44 do not respond to the polling signal in the first cycle of the operation of outputting a polling signal to each of the communication processing cards 41 to 44, the first cycle is completed within the time T1.

In the next (second) cycle of the operation of outputting a polling signal to each of the communication processing cards 41 to 44, the communication processing card 42 returns a response signal with information “H”, as indicated by a2 FIG. 17, when the controller 37b outputs a polling signal #2 to the communication processing card 42 as indicated by a1, where the information “H” indicates that the amount of data stored in the buffer exceeds the predetermined amount. Therefore, the controller 37b immediately outputs an allowance signal #2 to the communication processing card 42 to give a right of transmission to the communication processing card 42, as indicated by a3. Thus, the communication processing card 42 transmits data as indicated by a4.

When a predetermined time t elapses after the output of the allowance signal #2, the controller 37b outputs the next polling signal #3 to the communication processing card 43, as indicated by a5, and the communication processing card 43 returns a response signal with information “H” which indicates that the amount of data stored in the buffer exceeds the predetermined amount, as indicated by a6. Therefore, the controller 37b immediately outputs an allowance signal #3 to the communication processing card 43 to give a right of transmission to the communication processing card 43, as indicated by a7. Thus, the communication processing card 43 transmits data as indicated by a8.

When a predetermined time t elapses after the output of the allowance signal #3, the controller 37b outputs the next polling signal #4 to the communication processing card 44, as indicated by a9. The communication processing card 44 does not return a response signal in this cycle. Further, in the next (third) cycle of the operation of outputting a polling signal to each of the communication processing cards 41 to 44, the communication processing cards 41 to 44 do not respond to the polling signal as indicated in FIGS. 17 and 18.

In the fourth cycle of the operation of outputting a polling signal to each of the communication processing cards 41 to 44, which is indicated in FIG. 18, the communication processing card 42 returns a response signal with information “L”, as indicated by a11 in FIG. 18, when the controller 37b outputs a polling signal #2 to the communication processing card 42 as indicated by a10, where the information “L” indicates that the amount of data stored in the buffer does not exceed the predetermined amount. That is, the information “L” indicates that it is not necessary for the communication processing card 42 to transmit data immediately. Therefore, when the controller 37b receives the response signal, the controller 37b does not output an allowance signal, and only memorizes information on the response signal with information “L” from the communication processing card 42. Then, the controller 37b outputs the next polling signal to the communication processing card 43.

Thereafter, when the controller 37b outputs a polling signal #2 to the communication processing card 42, as indicated by a12 in FIG. 18, in the fifth cycle of the operation of outputting a polling signal to each of the communication processing cards 41 to 44, the communication processing card 42 recognizes that a right of transmission is given to the communication processing card 42, and transmits data as indicated by a13. When a predetermined time t elapses after the output of the polling signal #2, the controller 37b outputs the next polling signals #3 and #4 to the communication processing cards 43 and 44, respectively, in sequence, as indicated by a14. The communication processing card 44 returns a response signal with information “L”, which indicates that the amount of data stored in the buffer does not exceed the predetermined amount, as indicated by a15. Therefore, when the controller 37b receives the response signal, the controller 37b does not output an allowance signal, and only memorizes information on the response signal with information “L” from the communication processing card 44. Then, the controller 37b outputs the next polling signal to the communication processing card 41, i.e., starts the sixth cycle of the operation of outputting a polling signal to each of the communication processing cards 41 to 44.

In the sixth cycle, when the polling signal #2 is output to the communication processing card 42, the communication processing card 42 returns a response signal with information “H” indicating that the amount of data stored in the buffer exceeds the predetermined amount, as indicated by a16. Therefore, the controller 37b immediately outputs an allowance signal #2 to the communication processing card 42 to give a right of transmission to the communication processing card 42, as indicated by a17. Thus, the communication processing card 42 transmits data as indicated by a18. When a predetermined time t elapses after the output of the polling signal #2, the controller 37b outputs the next polling signals #3 and #4 to the communication processing cards 43 and 44, respectively. In this case, when the controller 37b outputs a polling signal #4 to the communication processing card 44 as indicated by a19 in FIG. 18, the communication processing card 44 recognizes that a right of transmission is given to the communication processing card 44, and transmits data as indicated by a20. When a predetermined time t elapses after the output of the polling signal #4, the controller 37b outputs the next polling signal to the communication processing card 41, i.e., starts the next (seventh) cycle of the operation of outputting a polling signal to each of the communication processing cards 41 to 44.

As described above, in the tenth embodiment of the present invention, information indicating whether or not the amount of data stored in the buffer exceeds the predetermined amount is sent to the controller 37b with a response signal to a polling signal, and the controller 37b immediately gives a right of transmission to a communication processing card which has an amount of data close to the full capacity of the buffer. In addition, when the above predetermined amount as a threshold is appropriately determined, a necessary capacity of the buffer in each communication processing card can be reduced, and the communication control apparatus can be produced at low cost.

(13) Eleventh Embodiment

The eleventh embodiment is different from the first embodiment in that each communication processing card informs the controller 37b of a priority level of data to be transmitted, and the controller 37b gives a right of transmission to each of communication processing cards which inform the controller 37b of the respective priority levels, in the order of the priority levels within each cycle of operation of outputting a polling signal to each of communication processing cards. The buffer control unit 81 illustrated in FIG. 14 attaches information on the priority level to the attribute bits 71 in the format of FIG. 4, which is output through the control lines 39 to the controller 37b.

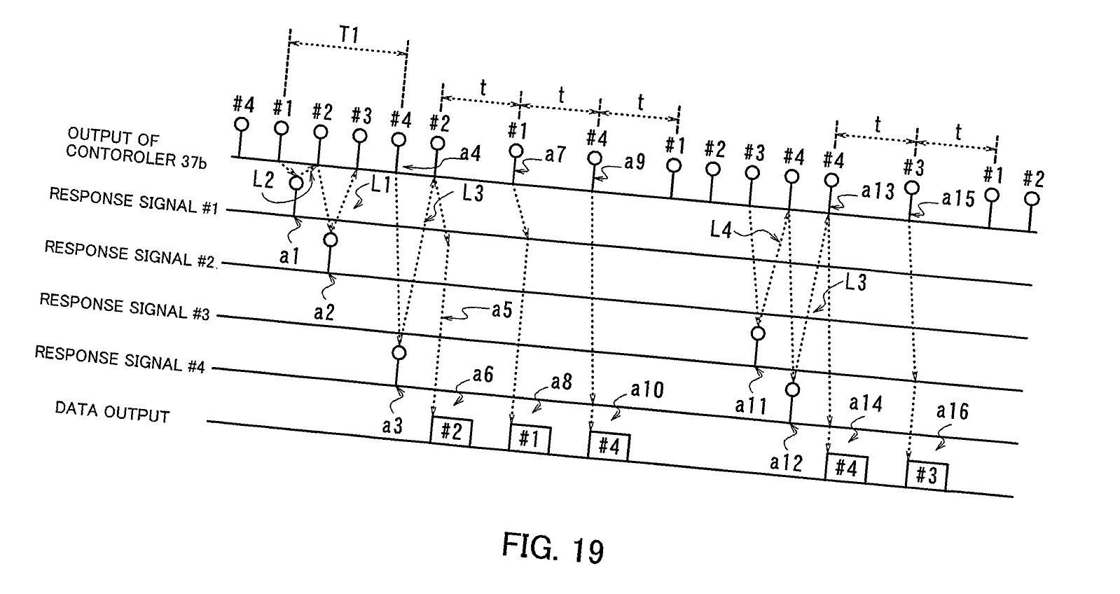

The operations of the communication control apparatus 30 of FIG. 2, performed in the eleventh embodiment of the present invention, are explained below with reference to FIG. 19, which is a timing diagram illustrating examples of operations of the communication control apparatus, performed in the eleventh embodiment of the present invention.

In the first cycle of the operation of outputting a polling signal to each of the communication processing cards 41 to 44, the communication processing cards 41, 42, and 44 return response signals, as indicated by a1, a2, and a3, respectively. To the attribute bits 71 in the response signals, the communication processing card 41 attaches the priority level L2, the communication processing card 42 attaches the priority level L1, and the communication processing card 44 attaches the priority level L3, respectively. The priority level L1 is the highest, followed by the priority levels L2, L3, and L4, in decreasing order.

Since, in this case, the highest priority level is L1, the controller 37b first outputs an allowance signal #2 to the communication processing card 42 so as to give a right of transmission to the communication processing card 42, as indicated by a5 in FIG. 19. Thus, the communication processing card 42 can transmit data, as indicated by a6. When a predetermined time t elapses after the allowance signal is output to the communication processing card 42, the controller 37b outputs an allowance signal #1 to the communication processing card 41 so as to give a right of transmission to the communication processing card 41, as indicated by a7. Thus, the communication processing card 41 transmit data, as indicated by a8. When a predetermined time t elapses after the allowance signal is output to the communication processing card 41, the controller 37b outputs an allowance signal to the communication processing card 44 so as to give a right of transmission to the communication processing card 44, as indicated by a9. Thus, the communication processing card 44 transmit data, as indicated by a10.

In the second cycle of the operation of outputting a polling signal to each of the communication processing cards 41 to 44, the communication processing cards 43 and 44 returns response signals indicating priority levels L4 and L3 as indicated by a11 and a12, respectively. Since the priority level L3 of the communication processing card 44 is higher than the priority level L4 of the communication processing card 43, the controller 37b first outputs an allowance signal #4 to the communication processing card 44 so as to give a right of transmission to the communication processing card 44, as indicated by a13. Thus, the communication processing card 44 transmit data, as indicated by a14. When a predetermined time t elapses after the allowance signal #4 is output to the communication processing card 44, the controller 37b outputs an allowance signal #3 to the communication processing card 43 so as to give a right of transmission to the communication processing card 43, as indicated by a15. Thus, the communication processing card 43 transmit data, as indicated by a16.

Since, in the eleventh embodiment of the present invention, the right of transmission is given to each of communication processing cards which has data to be transmitted, in the order of the priority level of the data to be transmitted, within each cycle of the operation of outputting a polling signal to each of the communication processing cards. Therefore, it is possible to differentiate user service handled by each communication processing card according to the priority level of the communication processing card.

(14) Twelfth Embodiment

The twelfth embodiment is different from the first embodiment in that each communication processing card informs the controller 37b whether or not the communication processing card has a request for allowance of successive transmission of further data following transmission of data corresponding to the current response signal, and the controller 37b successively gives a right of transmission to the same communication processing card when the communication processing card informs the controller 37b that the communication processing card has a request for allowance of transmission of further data, so that the communication processing card can successively transmit data.

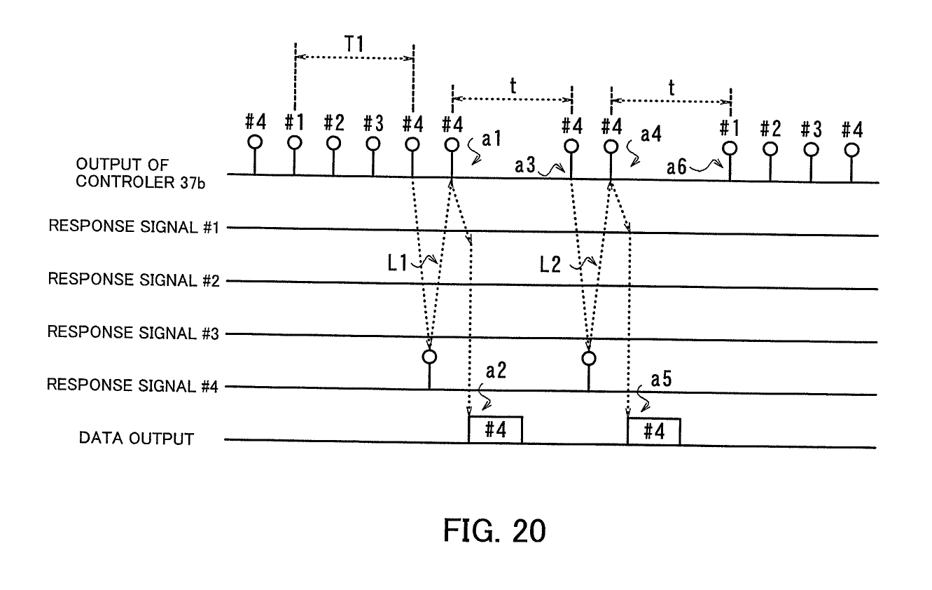

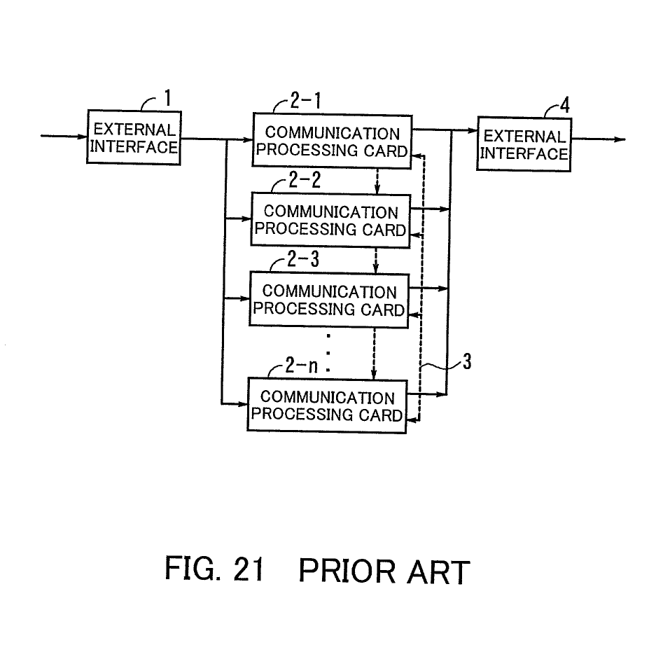

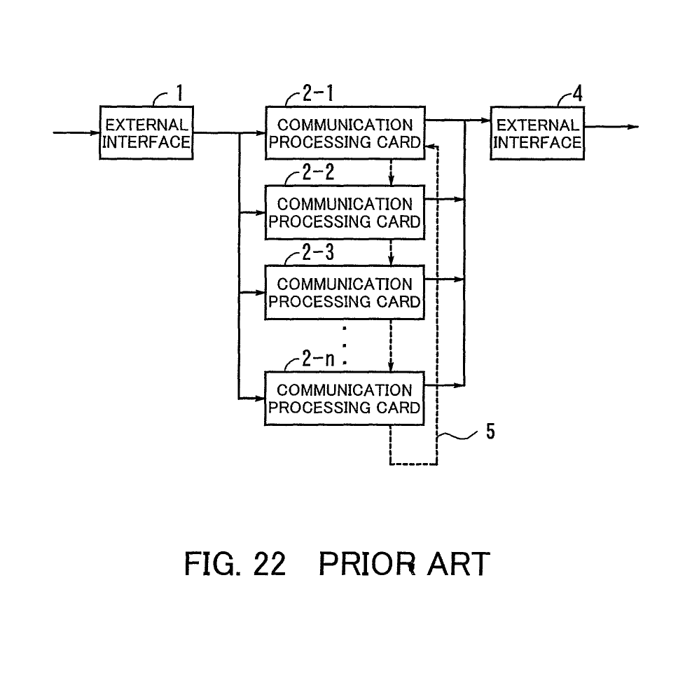

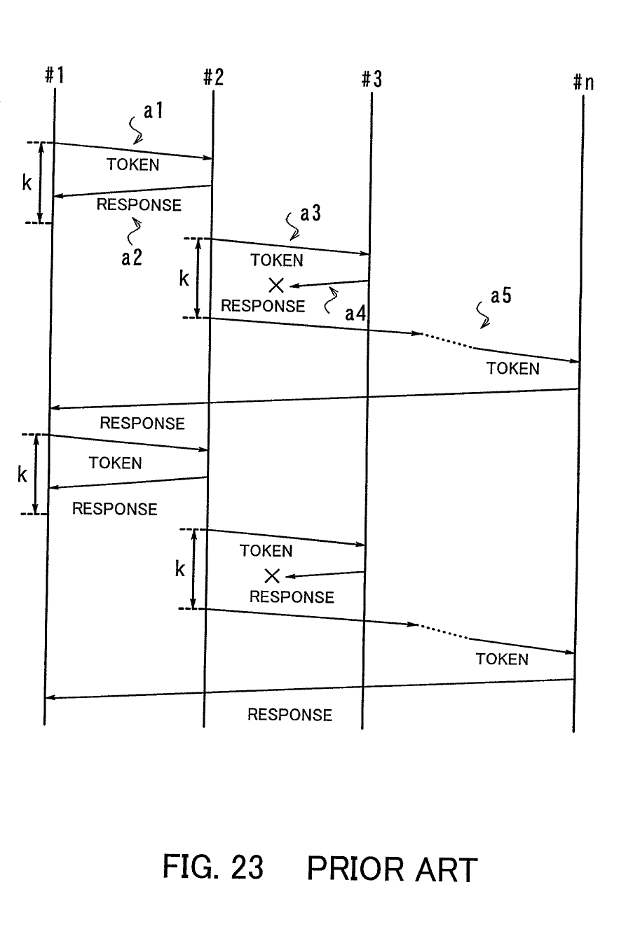

The operations of the communication control apparatus 30 of FIG. 2, performed in the twelfth embodiment of the present invention, are explained below with reference to FIG. 20, which is a timing diagram illustrating examples of operations of the communication control apparatus, performed in the twelfth embodiment of the present invention.

In the first cycle of the operation of outputting a polling signal to each of the communication processing cards 41 to 44, only the communication processing card 44 returns a response signal with information L1, which indicates that the communication processing card 44 has a request for allowance of successive transmission of further data following transmission of data corresponding to the current response signal. Therefore, the controller 37b successively gives a right of transmission to the communication processing card 44. In the example of FIG. 20, the controller 37b outputs the first polling signal #4 as indicated by a1, and the communication processing card 44 transmits data as indicated by a2. When a predetermined time t elapses after the first allowance signal #4 is output, the controller 37b outputs the second polling signal #4 onto the control lines 39 as indicated by a3. In response to the second polling signal #4, the communication processing card 44 returns a response signal with information L2, which indicates that the communication processing card 44 does not have a request for allowance of successive transmission of further data following transmission of data corresponding to the current response signal. Then, the controller 37b outputs the second allowance signal #4 as indicated by a4, and the communication processing card 44 transmits data as indicated by a5. When a predetermined time t elapses after the output of the second allowance signal #4, the controller 37b outputs a polling signal #1 as indicated by a6.

The above information L1 or L2 may be attached to the attribute bits 71 in the format of FIG. 4, which is output onto the control lines 39.

In the twelfth embodiment of the present invention, when the controller 37b receives from a communication processing card a response signal to which the information L1 is attached, the controller 37b successively outputs a polling signal to the same communication processing card. Therefore, when a communication processing card has very important data, the communication processing card can successively transmit the data.

(15) Other Matters

(i) Although, in the above embodiments, the present invention is applied to the control of transmission data output from the communication processing cards 41 to 44 to the switching control unit 37, the present invention can also be applied to control of reception data output from the communication processing cards 41 to 44 to the external interface 45. Further, the present invention can also be applied to control of both the transmission data and the reception data.

(ii) Although the communication control apparatus in the above embodiments are used in mobile communication, the communication control apparatus according to the present invention can be used in any other type of communication as well as mobile communication.

(iii) Any possible combinations of the functions of the above embodiments are included in the scope of the present invention,

(iv) The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

(v) All of the contents of the Japanese patent application, No.2000-037654 are incorporated into this specification by reference.

What is claimed is:

1. A communication control apparatus comprising:
a plurality of communication processing units each of which processes data; and
a control unit which controls said plurality of communication processing units;
said control unit comprises,
a polling unit which polls said plurality of communication processing cards in a first order which is predetermined, and
an allowing unit which allows an operation of outputting data from one of said plurality of communication processing cards when said control unit receives a response from said one of said plurality of communication processing cards;
each of said plurality of communication processing units comprises,
a responding unit which returns to said control unit a response to polling by said polling unit when said each of said plurality of communication processing units has data to be output, and is polled by said polling unit, and
an outputting unit which performs said operation of outputting data which is allowed by said allowing unit.

2. A communication control apparatus according to claim 1, further comprising at least one control line which interconnects said control unit and said plurality of communication processing cards, and said polling unit polls each of said plurality of communication processing cards by outputting onto said at least one control line identification information identifying said each of said plurality of communication processing cards.

3. A communication control apparatus according to claim 1, further comprising an installation detecting unit which detects whether or not each of said plurality of communication processing cards is installed, and said polling unit omits polling at least one of said plurality of communication processing cards when said installation detecting unit detects that said at least one of said plurality of communication processing cards is not installed.

4. A communication control apparatus according to claim 1, further comprising a time measuring unit which measures an elapsed time after said allowing unit allows said operation of outputting data from said one of said plurality of communication processing cards, and said polling unit polls another of said plurality of communication processing cards when a predetermined time elapses after said allowing unit allows said operation of outputting data from said one of said plurality of communication processing cards.

5. A communication control apparatus according to claim 1, wherein each of said plurality of communication processing cards further comprises an informing unit which informs said control unit that said operation of outputting data is completed, and said polling unit polls another of said plurality of communication processing cards when said control unit is informed by said informing unit that said operation of outputting data from said one of said plurality of communication processing cards is completed.

6. A communication control apparatus according to claim 5, wherein said polling unit polls another of said plurality of communication processing cards when a predetermined time elapses after said allowing unit allows said operation of outputting data from said one of said plurality of communication processing cards, and said control unit is not informed by said informing unit that said operation of outputting data from said one of said plurality of communication processing cards is completed.

7. A communication control apparatus according to claim 1, wherein said polling unit polls another of said plurality of communication processing cards when said operation of outputting data from said one of said plurality of communication processing cards is completed, where said another of said plurality of communication processing cards is arranged at a top of said first order.

8. A communication control apparatus according to claim 1, wherein said polling unit polls another of said plurality of communication processing cards when said operation of outputting data from said one of said plurality of communication processing cards is completed, where said another of said plurality of communication processing cards follows said one of said plurality of communication processing cards in said first order.

9. A communication control apparatus according to claim 1, wherein said polling unit successively polls one of said plurality of communication processing cards when said responding unit in said one of said plurality of communication processing cards sends to said control unit a request for allowance of successive output of data.

10. A communication control apparatus according to claim 1, further comprising a memorizing unit which memorizes at least one response received from at least one of said plurality of communication processing cards, and said allowing unit allows an operation of outputting data from each of said at least one of said plurality of communication processing cards in a second order determined in a predetermined way, after a cycle of operations of polling all of said plurality of communication processing cards is completed.

11. A communication control apparatus according to claim 10, wherein said second order is determined according to priorities assigned to the plurality of communication processing cards.

12. A communication control apparatus according to claim 10, wherein said second order is determined based on information included in each of said at least one response.

13. A communication control apparatus according to claim 12, wherein said information is determined based on importance or a type of said data to be transmitted from one of said at least one of the plurality of communication processing cards which returns said each of said at least one response.

14. A communication control apparatus according to claim 12, wherein said information is determined based on an amount of data which is held in a data buffer provided in one of said at least one of the plurality of communication processing cards which returns said each of said at least one response.

15. A communication control apparatus according to claim 1, wherein said allowing unit allows said operation of outputting data from said one of said plurality of communication processing cards, immediately after said control unit receives said response from said one of said plurality of communication processing cards, or after a cycle of operations of polling all of said plurality of communication processing cards is completed, based on whether or not said response is a type which indicates a request for immediate allowance.

16. A communication control apparatus according to claim 15, wherein said responding unit in each of said plurality of communication processing cards returns said type or another type of response, according to an amount of data held in a data buffer provided in said each of said plurality of communication processing cards.
